(19) United States
(12) Patent Application Publication
(10) Pub. No.: US 2003/0018510 A1
(43) Pub. Date: Jan. 23, 2003

(54) Method, system, and software for enterprise action management

(75) Inventor: Manuel J. Sanches, Reston, VA (US)

Correspondence Address: FOLEY AND LARDNER, SUITE 500, 3000 K STREET NW, WASHINGTON, DC, 20007, US

(73) Assignee: e-know

(21) Appl. No.: 10/112,048

(22) Filed: Apr. 1, 2002

Related U.S. Application Data
(60) Provisional application No. 60/280,100, filed on Mar. 30, 2001.

(51) Int. Cl. G06F 17/60

(52) U.S. Cl. 705/9

(57) ABSTRACT

A computer implemented method, system, and software of planning and managing an initiative, includes planning the initiative by determining the initiative tasks; generating an action plan including action items to accomplish the initiative tasks; and generating a dynamic organizational model to support the execution of the action plan, the organizational model comprising initiative participants, relationships between the initiative participants, and attributes of the initiative participants. Initiative participants are identified for assigning action items with reference to the organizational model and the identified initiative participants are notified.

### CROSS-REFERENCE TO RELATED APPLICATIONS

The present application claims the benefit of priority under 35 U.S.C. §119(e) of provisional application No. 60/280,100 filed on Mar. 30, 2001. The content of this provisional application is incorporated herein in its entirety.

### FIELD OF THE INVENTION

The present invention relates to methods, systems, software and tools to direct and manage enterprise wide activities or initiatives, for example, mergers, reorganizations, and/or other enterprise-wide strategic change or other activities.

### BACKGROUND OF THE INVENTION

A universal and critical need in the large company executives who manage acquisitions, reorganizations, product launches, and other strategic transitions or initiatives is the to manage large scale enterprise wide activities. When their transition plans involve multiple organizations and thousands of employees, management struggles to execute and often fails to achieve numerical targets. The estimated failure rate in M&A, for example, is 83%. Executives consistently identify the same obstacles to successful execution: chaos, communications obstacles, low compliance, and “flying blind” instead of truly managing an initiative (or its set of activities).

The prior art consists of project management, workflow, and collaboration software systems. All of these are useful for various aspects of an initiative. However, they are ineffective, separately or in combination, as a general framework for managing execution of initiatives. This is because they are optimized for managing routine activities (“workflow”) or for project planning. They are ineffective for managing activities that are (a) not routine, and (b) where the tasked individual or entities are now actually known until the tasks are progressively performed. Project management software essentially plans and models a project and captures data at discrete data points but do not autonomously deploy, execute, and track collective non-routine efforts (or initiatives). Collaboration tools often combine the elements of workflow and project management tools but do not avoid the problems of each as discussed above.

### SUMMARY OF THE INVENTION

The present invention alleviates some or all of the problems identified above and provides other advantages by providing a computer implemented method of planning and managing an initiative, the method including the steps of: planning the initiative by determining the initiative tasks; generating an action plan including action items to accomplish the initiative tasks; and generating a dynamic organizational model to support the execution of the action plan, the organizational model comprising initiative participants, relationships between the initiative participants, other business entities, and attributes of the initiative participants and other business entities.

In one aspect of the present invention, the step of generating an organization model is itself an initiative.

In another aspect of the present invention, the step of generating an organizational model includes: identifying an initial set of initiative participants including attributes and relationships associated therewith, with reference to user input and/or existing organizational information; generating notifications and queries to the initial set of initiative participants; collecting responses to the generated notifications and queries; and iteratively updating the initial set of initiative participants by adding or deleting initiative participants and/or altering the attributes and relationships associated therewith based on the collected responses.

In a further aspect the present invention includes identifying initiative participants for assigning action items with reference to the organizational model; and notifying the identified initiative participants of the assigned action items.

In another aspect of the present invention, the step of notifying the identified initiative participants of the assigned action items includes providing instructions and/or training on how to complete the assigned action items.

In another aspect, the present invention provides a computer readable medium having program code recorded thereon for planning and managing an initiative, the program code configured to cause a computing system to perform the following steps: planning the initiative by determining the initiative tasks; generating an action plan including action items to accomplish the initiative tasks; and generating a dynamic organizational model to support the execution of the action plan, the organizational model comprising initiative participants, relationships between the initiative participants, other business entities, and the attributes of the initiative participants and other business entities.

In another aspect, the present invention provides an action item management system for planning and managing an initiative comprising: an action planning unit for generating an action plan comprising action items to complete the initiative tasks; an action management database for storing a dynamically generated organizational model and information relating to the action items; an action item scheduler for assigning and scheduling action items; an action item notifier for notifying initiative entities of assigned action items; and an action item response unit for receiving action item responses from initiative participants and updating the action management database, wherein the action planning unit iteratively and dynamically generates the organizational model based on organizational information and responses received from initiative participants.

### BRIEF DESCRIPTION OF THE DRAWINGS

The accompanying drawings, which are incorporated in and constitute a part of the specification, illustrate presently preferred embodiment(s) of the invention, and together with the general description given above and the detailed description of the preferred embodiment(s) given below, serve to explain various aspects of the invention.

FIG. 1 is a diagram illustrating the interaction of the MECA action management platform, the action management teams, and action participants, and action support teams.

FIG. 2 is another diagram that illustrates the interaction between MECA's action management platform, the action management team, the action participants, and the action support team.

FIG. 3 is a table illustrating the roles of business and technical users.

FIG. 4 is a diagram illustrating the interactions of an action support team.

FIG. 5 depicts the phases of a generic, MECA-assisted change-management initiative.

FIG. 6 is a diagram illustrates tracking the progress of action item in phases.

FIG. 7 is a diagram illustrating the four stages of an action item execution cycle.

FIG. 8 is a program/package structure diagram according one implementation of the present invention.

FIG. 9 is an exemplary MECA Architecture Diagram that illustrates exemplary classes used in one implementation of the present invention

FIG. 10 is class diagram illustrating the relationships of the Task class.

FIG. 11 is an UML diagram that provides an overview of he StartCondition class.

FIG. 12 is an UML diagram providing an overview of the Question class.

FIG. 13 is an UML diagram illustrating the Response class.

FIG. 14 is an UML diagram illustrating the Profile class.

FIG. 15 is an UML diagram that illustrates the ResponseMatcher class.

FIG. 16 is an UML diagram that illustrates the Individual class.

FIG. 17 is an UML diagram illustrating exemplary completeness metric classes.

### DETAILED DESCRIPTION OF THE PREFERRED EMBODIMENTS

The present invention manages the deployment, execution, and tracking of initiatives. “Initiatives” means coordinated non-routine efforts of large number of individuals and entities (up to many thousands or even more), for example, in an extended organization. Examples include, without limitation, regulatory compliance initiative, institution of new policies or practices, retraining projects, product launches, mergers and acquisitions, and large scale integrations. Some of the exemplary common characteristics of such initiatives include: non-routine, large scale, high chaos, communication intensive, transfer of knowledge, exchange of data, assignments of roles, and providing and tracking status. This contrasts with the more routine projects to design, build, develop, implement, engineer, or transport projects or systems.

The system provided by the present invention employs a novel type of interactive communications that is built upon a data model of a company or organization (“organizational model”). The organizational model includes human initiative participants as well as other non-human entities (such as divisions or groupings) as well as their attributes and relationships. The essential steps of initiative execution are linked to a largely automated control loop. The essential steps are: (1) Planning the initiative; (2) mapping or modeling the organization of potential initiative participants and entities (collectively “initiative entities”); (3) matching initiative entities to tasks (or action items); (4) notifying tasked entities; (5) presenting task instructions to the tasked entities; (6) personalizing the task based on attributed of the entities; (7) performing the tasks; and (8) measuring individual and collective outcomes of initiative performance; and (9) adjusting the timing, sequence, or targeting of individual or collective tasks based on those outcomes.

One aspect of the present invention is the circular interdependency between the organizational model and the initiative tasks performed by the organization. That is, (a) the tasks are delivered to individuals who match a description or attribute in the organizational model; (b) tasks can contain personalized lists of individuals, entities, or things that are related to the task recipient based on the organizational model; (c) results of tasks modify the descriptions or attributes in the organizational model, of both the tasked individual, and related business entities named in the task. Therefore, the act of mapping the organization itself may be itself merely an initiative and also a by-product of initiative performance. The system can autonomously construct an increasingly detailed model of the organization by first sending questions to individuals about their roles, attributes, and functional relationships to other people and business entities, and then correlating the responses in, for example, a hierarchical model of the organizations business entities and individuals (collectively “initiative entities”).

In one embodiment, the present invention provides MECA (Managed Enterprise Communications Command and Control Architecture), implemented by a hosted software tool that allows management to direct and measure the success of acquisitions and other high value, large scale initiatives.

MECA achieves this by seamlessly integrating each phase of initiative execution. MECA synchronizes participation of all individuals and business structures in the action plan—from the boardroom to the mail room-and tracks collective progress in real-time. Distributed management teams can manage multiple action plans and thousands of users, communications, and action items.

In one aspect, MECA is a hosted application that requires no new hardware or software, little or no training for most users, and can be implemented in a short period.

The value proposition of MECA includes a management benefit and a strategic benefit. As the management benefit, MECA gives executive management the tools and information necessary to direct synchronized, consistent execution of their strategic plans across an entire or multiple organizations. Real-time feedback on progress, compliance rates, and outcomes allows management to make mid-course corrections to keep the initiative on track. Administrative overhead and delays are also greatly reduced.

As the strategic benefit, MECA maximizes and accelerates returns from strategic initiatives. In post-merger integration, for example, MECA enables management to achieve more revenue and cost synergy targets, and to achieve them more rapidly, predictably, and completely.

MECA provides the six core management functions as discussed next.

\mathring{1} Manage strategic objectives. Use MECA to centrally capture and communicate strategic objectives. MECA closes the loop on these communications by requiring affected managers to acknowledge, agree, or confirm understanding.

\mathring{2} Manage people. Use MECA to define and track group membership, from ad-hoc teams to company divisions. Pro file all employees and create dynamic, self -maintaining “maps” or “blueprints” of the organization (i.e., an organizational model). Browse or search by division, role, transition team membership, personnel data, and more.

\mathring{3} Manage transition plans. Multiple teams work in parallel to create hierarchical action plans. Plans may be imported from MS Project or created directly in MECA. View plans and plan progress from anywhere.

\mathring{4} Manage task communication & delivery. Use MECA's form-builder to quickly create closed-loop mass communications and interactive “mass action items” that are embedded directly in transition plans.

### EXAMPLES

Notifications, Web-based training, policy communications, & other knowledge transfer

Employee queries, data forms, and surveys

Role assignments, & other tasks

\mathring{5} Manage execution. MECA dynamically targets mass action items (see above) based on employee profiles. MECA escalates until required employee responses are collected. Call center resources can be recruited by the system on demand. MECA business rules are based on individual or collective action item results.

\mathring{6} Manage data. View real-time reports on status, progress, outcomes Auto-calculate and compare actual performance to strategic objective targets. Create self-updating custom Web reports. View MECA data in Excel, Visio, or Crystal Reports with a mouse-click.

As a technology overview, in one embodiment, MECA is a secure, scalable application written in 100% Java and run on UNIX- or Linux-based servers. Other technology features of one embodiment of MECA includes: web-based tools and screens for managing teams, plans, communications, documents, interactive employee action items, & reports; action items presented to employees and fulfilled via multiple communications modes: web, e-mail, pager, telephony, instant messaging, call center, USPS, and more; can be integrated with employee portals, network directories, HR and CRM systems; and dedicated hardware, software, & VPN fully managed by a MECA provider know and hosted in an environment providing data, access, and network security.

Some of the key differentiators of MECA are discussed next. MECA contains elements of collaboration, project management, work flow, and executive decision support tools. However, MECA is uniquely specialized for accelerating strategic change because of the following features: fully integrated—MECA dynamically links people, plans, & action performance in a single, Web-based, execution framework; truly universal—MECA is designed to be used by up to thousands (or more) to actively coordinate everyone's participation in the initiative; powerful yet simple MECA is far simpler to use than project management and other tools, yet is more powerful for end-to-end management of the complete initiative life cycle; highly automated—MECA automates organizational blue-printing (or modeling), notifications, action-item delivery, follow-up, escalation, data gathering, reporting, and more; and transparent—MECA provides a real-time window into organizations, team structures, progress, results, performance, and accountability.

In one embodiment, MECA is a hosted application designed to accelerate and simplify execution of enterprise-wide complex initiatives such as launching new products, company re-organizations and mergers and acquisitions.

MECA tightly integrates all five key components of enterprise-wide action: (1) Planning; (2) Organization; (3) Communication; (4) Performance; and (5) Tracking.

MECA is entirely specialized for enterprise-scale action (or initiative) management, where the operative words are “action” and “enterprise.” MECA is not re-purposed technology for workflow or project management. It's not a modified version of software originally created for knowledge, document or resource management.

MECA integrates the management of organizational structures, action plans, communications, action and performance management, and tracking and reporting-all in a single, Web-based framework (in one embodiment) that's actually easier to use than many products, such as MS Project, which address only a portion of the initiative execution cycle. Among other advantages, MECA requires no new infrastructure or client software, is independent of any particular messaging technology, can reach across organizational boundaries, provides a self-maintaining inventory of human capital, and targets action item participants dynamically.

Integrated Execution Framework

MECA, in one embodiment of the present invention, is an integrated, Web-based platform designed to manage all facets of initiative execution. Executive teams can simultaneously manage any number of critical initiatives, of any size. Via MECA's easy-to-use Web interface, users create, browse and manage action plans, team structures, and reports. MECA sends key communications and action items to initiative participants via their preferred communications methods, such as e-mail, PDA, pager or cell phone. Initiative participants across the organization directly perform action items.

MECA allows distributed teams to create unified, coordinated action plans in parallel. These action plans are simpler than traditional project plans and unfold as coordinated, cascading chains of carefully targeted key communications and interactive action items.

As action plans unfold, MECA notifies initiative participants, presents them with interactive action items, and prompts them directly for action or responses (see Interactive action item types, next page). MECA can use any user response (or even inaction) to trigger other action items or business rules, and to update reports.

In mergers and other large scale initiatives, entire groups of employees must be mobilized for specific activities. MECA allows managers to target action items specifically for particular roles, ad-hoc groups or whole categories of employees, based on roles and profile information. As roles change, MECA automatically initiates, cancels or retargets action items and communications. MECA also provides for effortless tracking and reporting by providing the following exemplary capabilities: browse all ongoing initiatives; roll-up/drill-down initiative progress, results; browse current org chart w/all ad-hoc teams; list persons/teams associated with an action item; list action items associated w/individuals or teams; and view individual & collective performance.

In preparing MECA for action, in one embodiment, managers use MECA Web interface to define: team structures; action plans (can also import from MS Project or other project planning tool); notifications and key communications; interactive action items; performance metrics and other business rules.

MECA also facilitates the action item execution cycle. Certain action items must be performed in parallel by many employees, based on their roles in the organization, e.g., sales training. In these cases, MECA: identifies appropriate recipients based on profiles, business rules, or other action items; notifies each recipient, and escalates if necessary; presents the action items as interactive media; facilitates or guides performance to completion; chains action items together into simple workflows, per the customer's action plan; tracks and reports consolidated progress; and follows up on every action item.

MECA provides for interactive action item types. MECA tasks, designed to be completed by multiple initiative participants, can have Web forms and other interactive media attached to them right in the action plan. These task interfaces guide the recipient through five exemplary types of action item performance: closed-loop notifications; queries multi-choice surveys, data forms and more; knowledge transfer—simple to complex instructions with confirmation of understanding; Role/responsibility assignment—manager assigns another action item and MECA follows-up; and miscellaneous task/directive—user performs and indicates completion or progress;

One exemplary use of MECA is the integration of mergers and acquisitions. MECA is the ideal platform for enabling multiple teams to work simultaneously on the multiple objectives.

Throughout the integration process, MECA provides all managers a real-time view of plans, team structures, activities, performance, progress, and actual data generated by the integration. Specific activities facilitated by MECA include: capturing & communicating deal objectives; implementing employee retention plans; targeting multiple merger announcements to different internal constituencies; and closing the loop; identifying processes, responsibilities, infrastructure, and resources to integrate; coordinating functional areas, business lines, etc.; creating and validating integration plans; assigning new roles and responsibilities; collecting employee information; creating employee accounts on systems, etc.; integrating sales, product, service training; integrating policies and procedures; integrating compensation structures; integrating performance management; cultural evaluation & integration; organization structure mapping, design & integration; and IT systems transitions, user training

In one embodiment, MECA is designed as a hosted application, designed to eliminate most implementation and integration-related delays, to accelerate scaling and customization, and to allow rapid, transparent integration of outsourced call center services. Customers access MECA via the customer's existing intranet and Virtual Private Network (VPN) infrastructure.

Advantages of MECA's hosted implementation are: rapid (10 time plus faster) technical implementation; transparent support and upgrades; maximum scalability; global infrastructure; transparent integration of Action Support Centers; and MECA's hosting facility meets existing standards, for example, DoD standards for SCIF protection.

The five key obstacles to execution of an initiative that are addressed by the present invention are summarized below and expanded upon in the following pages.

1. Maintaining independent plan momentum. The execution plan cannot act on its own. It exists only in files, documents, and people's minds. Consequence: Maintaining momentum requires constant attention and energy.

2. Targeting communication & action items. Action items cannot be precisely targeted and delivered to all and only the right people. Result: Unintended internal “spamming” of the wrong recipients, and unintentionally ignored instructions by the right ones.

3. Ensuring consistent action performance. There is no efficient way to ensure high compliance and consistent performance of action items. Result: the project is completed but the results are less than desired.

4. Achieving closed-loop management. It is impossible to collectively close the loop in real-time on action progress, results, and status of thousands of action items. Result: Management flies blind.

5. Reducing administrative burden. Administrative and managerial burdens create enormous resistance to plan progress. The larger the project, the larger the burden. Irony: The more the organization tries to “do the right thing” administratively, the more resistance it creates.

Challenge #1

Giving the Action Plan a Life of Its Own

Communicating the relevant parts of the execution plan to every affected individual is difficult enough. But to then create and maintain momentum in your strategic initiative can be tremendously difficult.

The reason is that an operation plan has no real existence outside of the minds and passive documents of your managers. The plan does not live and breathe on its own. So plan execution must rely on the sheer will power of individuals who have limited time, limited information, and many competing responsibilities. Also, these individuals must go home at night, take sick leave, and occasionally retire.

The challenge is to be able to define and capture the operational plan in an external, self-directing system independent of any one person. The plan would “know” in some sense what needs to be done, by whom, under what conditions, and when. The plan would proactively direct its own execution, report on status and progress, and signal when intervention is required.

Challenge #2

Precision Targeting of Action Items

Of course, not everyone in the organization should receive every notification, query, directive, and so on. But exactly who should perform which task? Who should respond to which query? Who needs what new knowledge?

When directives, queries and notifications are un-targeted or broadcast, they are often ignored. This create chaos, confusion, and delays while managers attempt to get their messages heard above the noise with more targeted follow-up messages and phone calls.

Moreover, targeting precision must be maintained even when (1) there are thousands of action participants, (2) they are spread across multiple organizations, (3) no one person can know exactly who must perform which action items, and (4) over the course of the initiative, a large percentage of action participants will change roles, transfer, or leave the company altogether.

Precision targeting cannot be achieved using the data from the company's HR database. A sophisticated new targeting paradigm is absolutely critical to high performance, large-scale execution.

The challenge is to target and deliver thousands of action items quickly, precisely, and automatically. Since typically no one person knows all of the possible recipients, targeting must be based on individual roles and profile information, previous action item results, and managerial fine-tuning of action item target lists. Action items must be delivered to all and only those who should receive them.

Challenge #3

Maximizing Performance and Compliance

Even if a memo is received and read by every one of two hundred intended recipients, there is no guarantee that the action item will actually be performed by all two hundred, or performed in the same way, or in the same time frame.

Why? The recipient may not be absolutely sure that the action item applies to her. She may underestimate the urgency of the task. She may need more specifics. Her interpretation of the instructions may not be what you intended. She may believe that the task is more complicated than it really is, and delay attempting it. She may not believe that you have the authority to require her cooperation. Or she may believe that there are no consequences for not cooperating.

E-mail, memoranda, and even training seminars don't deliver acceptably high compliance rates. It is impossible to address every possible question or eliminate every ambiguity. But when the action item communication leaves too many questions unanswered, the result is delayed, incomplete, and inconsistent execution.

The challenge in achieving consistent compliance in large-scale actions is to create an entirely new, structured framework for (1) presenting required actions,(2) minimizing ambiguity, (3) actively guiding performance, (4) providing various forms of assistance, (5) collecting responses or results, and (6) capturing exceptions. The framework must also be essentially “transparent” to users because, to be accepted, it cannot noticeably change the way people perform their work.

Challenge #4

Closing the Loop-Everywhere

As marching orders and other communications are passed like batons across the organization, the execution of those instructions becomes invisible to any manager one or two levels away. It is difficult to know who has gotten the message, who has acted on it, what are the results, and where intervention is necessary. This is because most communication is open loop and does not provide systematic feedback that can be suitable recorded.

How can the loop be closed? Status reports are better than nothing, but they are slow, resource draining, not always accurate or objective, and always out of date by the time you get them. E-mail and other messaging media are fundamentally designed for one-to-one communications loops. If everyone diligently apprised everyone else of everything, every executive would drown in unconsolidated, unusable status information.

Therefore, there is a need to close the loops between a relatively small number of managers and an arbitrarily large number of participants in the initiative.

Like targeting, closing the loop is not a “nice to have.” If the loop cannot be closed on the aggregate activity of the entire organization, the executives are flying blind. A new mechanism for closing the many-to-many loop completely, permanently, and without additional administrative burden, is an absolute requirement for high performance execution.

Challenge #5

Slashing the Administrative Burden

Large-scale actions generate enormous quantities of status reports, e-mail queries, follow-up phone calls, printed materials, mailing, and so on. The day-to-day administrative and management overhead of operational plan execution is huge but the “signal-to-noise ratio” is too low.

The conundrum is that the quality of administrative and managerial oversight has to improve, and yet the administrative and managerial burden must be reduced, not increased. A solution that does not decisively address the administrative challenge is no solution at all.

The challenge is to provide a system that reduces, not increases, the number of non-essential administrative and managerial tasks. At the same time the system must provide more thorough follow-through on action items and more, not less, information about the status and results of those action items.

To address some or all of the challenges addressed above, one embodiment of the present invention provides a computer implemented system, method, and software referred to herein as MECA. (“MECA” stands for “Management Enterprise Communications/Command/Control Architecture”). MECA has been engineered from the ground up to address each of the five central action management challenges, and to dramatically increase the speed, precision, success rate, and cost-effectiveness of large-scale actions.

In one embodiment, the present invention a MECA action management platform, Action Support Centers, and Action Management services. Some of the functions provided by MECA in this embodiment include: (1) MECA allows client action plans to be transformed into adaptive, agent-like business processes (system action plans); (2) MECA continuously targets action participants, precisely and automatically, using contextual information and a self-maintaining model of the entire organization (develops a dynamic system organizational model); (3) MECA interactively presents action items and actively guides, facilitates, and assists individual performance by action participants, via their preferred communications media (system task targeting and system notifications); (4) MECA closes the loop on all action items, individually and collectively, by reporting five key real-time metrics: targeting, penetration, progress, results, and intervention (system action items and system action item objects); and (5) MECA automates or eliminates much of the administrative and managerial overhead of complex operational plans.

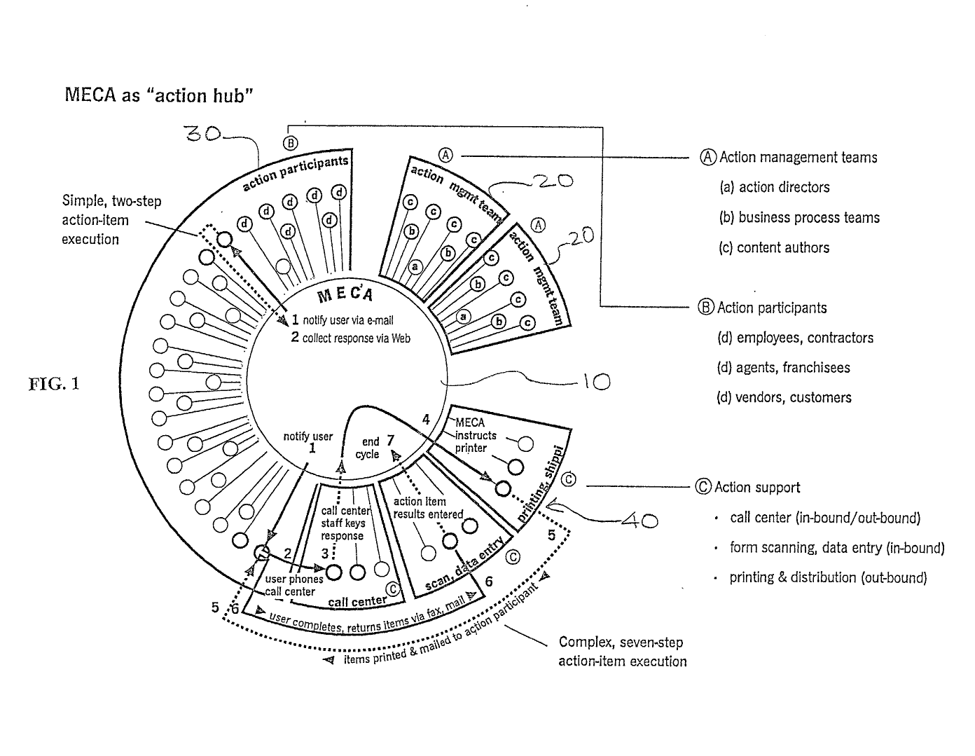

With reference to the figures, FIG. 1 is a diagram illustrating the interaction of the MECA action management platform 10, the action management teams 20, the action participants 30, and the action support teams 40.

In one embodiment, the technological core of the MECA action management platform 10 is an extranet application hosted and maintained entirely by a MECA provider for the client. embodiment. MECA's purpose is to manage coordinated, synchronized, systematic execution of cascading chains of action items up, down, and across the organizational chart. MECA identifies and notifies action item recipients, presents the action items as interactive media, guides performance to completion, reports consolidated progress, and follows up on every action item. Any action item result (or inaction) may trigger other action items. As a strategic initiative unfolds, MECA graphically displays Action status, progress and consolidated results to management, in real-time.

As shown in FIG. 1, in a simple interaction, the MECA action management platform 10 may notify an action participant 30 directly by e-mail and collect the response from the action participant 30 through the web. Alternatively, in a complex interaction, the action management platform 10 and the action participant may interact using a complex seven action item execution. (1) The action participant 30 is notified by the action management platform 10 of an assigned action item. (2) The action participant communicates with the action support center 40 (for example, by calling into a call center). (3) The action support center inputs the action center participant communication, which causes the (4) action management platform 10 to cause the action support center to print and (5) transmit the required items to the action participant 30 (for example, by mailing). (6) The action participant 30 then completes the required items and communicates back to the action support center 40. (7) The action support center 40 then enters the action participant 30 communication into the action management platform 10 to complete the action item.

Staffed and managed Action Support Centers (or Teams) 30 are an aspect of the solution provided by the present invention and further accelerates action execution. Action support teams at the may be dedicated, centralized resource pools for administrative, communications, and logistics support. For example, an action support team may contact employees (or other action participants) by telephone to notify them of action items, determine the status of an outstanding action item, or deliver a telephone survey to the employee. Employees can call the action support center to conveniently relay the results or status of an action Item, or for assistance or clarification.

In addition to call-center functions, action support centers 30 may also receive faxed or mailed forms or reports and perform data entry, perform printing, shipping and other fulfillment functions in the service of the action or initiative. In one embodiment, all action support center 30 staffing, planning, and training is provided and managed for the customer by a provider of MECA.

Action management teams 20 create and deploy actions and action Items (see below) on MECA. Action management teams are typically composed of members from both the customer organization and a MECA provider. These teams define the business objectives of the customer's initiative, translate those objectives into actions and action items, monitor action execution, and “tune” the action as it unfolds to ensure that business objectives are met.

One of the key conceptual building blocks of MECA is the Action. The Action is the framework in which a customer's operational plan is defined and captured in MECA. MECA Actions are built from many interactive, agent-like action items. MECA action items include, for example, notifications, directives, knowledge transfers, role assignments, and management queries. MECA presents action items to action participants 30 either electronically (via e-mail, interactive Web forms, voice prompts, etc.) or via human intermediaries on Action Support Teams 30. MECA may manage thousands of action item execution cycles simultaneously.

Some of the benefits of MECA discussed in detail in the following paragraphs include: increase execution speed; cost reductions; high penetration and compliance; closed-loop management feedback and control; reduced confusion and disorganization; and creation of a constantly improving (“dynamic”) structural asset.

Increased Execution Speed

Perhaps the most immediate benefit of MECA is to accelerate plan execution. MECA is designed to speed action in several ways:

Process automation. MECA eliminates many delays inherent in the vast majority of chain-of-command communications. MECA accomplishes this by automatically targeting participants for action items, modifying target lists based on management input, notifying participants of action items, presenting the action Item to be performed, providing interactive help, collecting and consolidating results, and using results of action Items to trigger or target new action items. For many action-item execution cycles, this entire sequence can occur without human intervention.

Escalation. MECA delivers sophisticated and flexible escalating notifications to help keep participants on track. This is critical because most or all action participants will have many incoming communications, and may not realize the importance of the instruction or query on the first prompting.

Human-in-the-loop backup. When personal communication is required in the escalation sequence—or even for the very first notification—MECA can instantly direct this tasks to the action support team call center. These teams are entirely dedicated to these functions. As a result they can normally follow up more quickly than managers who have many other responsibilities.

Rapid, well-informed intervention. MECA's closed-loop feedback (see below) allows management to instantly determine if, where, and when intervention is required to get an action back on track.

Cost Reductions and Revenue Enhancement

MECA contributes directly to the bottom line by reducing costs and increasing revenues in at least four ways:

Reduce integration delay cost. As discussed above, MECA accelerates integration. And the greatest cost in acquisition integration is delay. Every month that MECA shaves from the integration plan translates directly to the bottom line.

Reduce execution costs. MECA does the work of an army of managers and administrators. We believe that to attempt to duplicate MECA's action management functions via administrative and managerial oversight would require an impossibly large, intrusive, and costly personnel infrastructure.

Increase front-office efficiencies. MECA is directly applicable to revenue enhancement initiatives. MECA was designed to accelerate product line changes, product launches, sales force evaluation and training, customer-base and market research, and similar initiatives. In fact, MECA automatically quantifies and reports its own performance with respect to benchmarks and milestones, in real-time.

Rationalize the labor force. Fourth, MECA is a powerful tool for reducing labor costs through a better understanding of the organization's make-up and performance “landscape” (see “Create a structural asset,” below). The larger the work force, the greater MECA's impact in this area.

High Penetration and Compliance

MECA is designed to increase compliance rates through four means:

Automation. MECA automatically targets and notifies participants, escalates notifications, triggers action items based on roles, context, and business rules instead of simply broadcasting them.

Human intervention. MECA automatically inserts a human in the loop when needed (or when requested by an action participant).

Assistance. When a participant is performing an action item via MECA, MECA provides contextual information, links to help pages, and links and phone numbers for personal action support.

Management feedback. When penetration rates are not up to standard, this fact is instantly quantified and reported to allow immediate resolution.

Closed-Loop Feedback and Control

The closed action execution cycle is the essence of action management with MECA. Whatever the penetration or compliance level, management cannot action on information it does not have.

Since every interaction with MECA is closed-loop, the authorized managers will be able to see the progress and results of every action Item individually, or consolidated, in real time. This allows unprecedented power for immediate, well-informed intervention when action plan results to not meet objectives. Within the system, this allows MECA to trigger, re-target, or modify action Items instantly when a loop is closed by any action participant.

Chaos Management

The inevitable chaos factor is a common source of frustration in large scale actions in general, and acquisition integration in particular. No system or methodology can eliminate all disorganization and confusion when very large numbers of individuals attempt to work together. But solution provided by the present invention is specifically designed to reduce disorganization in four important ways:

Process. The action management team structure and action plan establishment method establishes discipline in the planning and management process.

Repeatability. MECA provides a structured yet flexible framework for consistently repeatable execution success.

Automation. MECA eliminates many other sources of disorganization by automating the targeting, notification, and follow-up Action items.

Communication. In large and/or dynamic employee populations, MECA is more effective than traditional channels for ensuring that a message is received and understood by all and only those for whom the message is relevant.

Admin support. The present invention's Action Support framework integrates specialized teams to provide logistical, communications, and execution assistance.

Create a Structural Asset

In contrast with pure consulting-based solutions, a MECA-based solution does not disappear when the consultants and employees go home. The act of using MECA creates a lasting asset whose value increase the more it is used.

Organization model. MECA automatically creates a self-maintaining model or “map” of the organization. This map represents every individual, role, entity and reporting relationship, and potentially every response on every action item deployed through MECA. Thus MECA's organization model grows more detailed and powerful the longer MECA is used, the data within it can be reported at the level of the individual or consolidated at the level of any organizational unit of the company.

Living action plan. When an action plan is deployed as an action on MECA, that action plan has become more than a static plan. An action is no longer locked in the minds and documents of its architects. An action is a resource independent of any individual.

Re-usable resource. Working with MECA creates a growing knowledge base of repeatable, tunable procedures. Actions can be reused and modified on the fly to improve performance. The results of the action can be replayed to apply lessons learned to future actions. And Actions can be used as templates for new actions.

When to Use MECA

MECA has countless applications. Indicators of when a company or a management challenge is a good fit for MECA include rapid change, large scale, compliance requirements, strategic value, and the need for specific business intelligence.

Rapid Change

MECA is designed for the action management challenges of dynamic, evolving, or fast-growing organizations. Specifically, these are organizations with:

Complex or dynamic product lines, regulatory requirements, or competitive environments

M&A, restructuring, or re-structuring, or re-organization challenges

Employee populations experiencing high growth, turnover, or transitions

Mandatory Compliance

Very importantly, MECA is designed for actions where, in general, response to properly assigned action items is mandatory. In this regard MECA is like an accounting system for action.

In general, MECA is not as useful for “soft” applications such as the simple diffusion of information, optional career training, or non-strategic awareness initiatives. Using MECA instead of traditional communications channels for “nice to have” instead of “need to have” compliance issues may actually undermine the effectiveness of MECA.

Strategic Value

MECA is used when the value of compliance can be at least roughly quantified, and where compliance in the action is potentially as important to the organization as compliance with other mandatory systems for financial reporting, HR and account management.

Critical Role of Business Intelligence

MECA should be used when there is a clear operational need to determine or measure at any given time: who should perform which tasks, or respond to which queries? (The targeting metric); how many have received instructions, queries, or required information? (The penetration metric); how many have actually performed the task, responded to the query, or acquired the new knowledge? (The progress metric); what are the collective outcomes of those actions? (The results metric); where and how much intervention is required? (The intervention metric).

Accelerating Post-Merger Integration with MECA

Research consistently indicated that two key ingredients of acquisition success are rapid integration of the acquired company, and universal understanding and buy-in of strategic objectives. The MECA action management platform is tailor-made to achieve both objectives.

Integration Challenge

An acquiring company's post-merger strategy may include consolidating all process, objectives, resources, and responsibilities of the two organizations:

Processes. Sales practices, customer service standards, fulfillment and delivery methods, IT system operating procedures, engineering methodologies, human resource policies and procedures.

Objectives. The mission, strategic objectives, tactical priorities, market position, image, customer service philosophy, and more. To gain tangible benefits from a merger, these intangibles must be thoroughly aligned in both organizations.

Resources. Human resources, balance sheets assets including tangibles such as cash, and intangible such as patents, plus off-balance sheet assets such as image and reputation.

Responsibilities. Obligations to acquired company constituencies. These include employees, vendors, shareholders, customers, and lenders-especially those constituencies with interests protected by the acquisition agreement.

Integration as Action Management

Clearly, acquisition integration consists of a number of large-scale actions, each made up of many smaller action items. All of these integration effects require carefully managed projects consisting of notifications, directives management queries, and training or instruction.

Integrating operational processes alone may ultimately require hundreds of such projects and thousands of action items, involving individuals in both the acquired and acquired organization.

MECA Integration Benefits

The solution is to map these projects onto automated MECA actions and action Items. This approach provides clear advantages over brute-force, chain-of-command approaches:

Speed and precision. MECA drives more rapid, synchronized, and consistent execution than possible with traditional methods. This may be the most important benefit of MECA in the acquisition integration environment.

Intelligence. MECA allows management to track the progress of all these efforts, and of the integration program as a whole, in real-time. Without this capability, mid-course corrections are difficult or impossible.

Full compliance. MECA maximizes compliance rates when near perfect compliance is vital.

Order. MECA tames much of the chaos and complexity of post-acquisition transitions.

Cost-effectiveness. MECA reduces integration costs by reducing time-to-integration, and by eliminating much administrative overhead, managerial process monitoring, and human error.

Other Action Management Applications

Acquisition integration is just one of many applications for MECA. Other cost-effective, high-value applications include training and best-practices initiatives, key policy changes, reorganizations, product rollouts, and complex IT system implementations. Some of these are discussed briefly below.

Key Policy and Procedure Changes

MECA is used to reduce the administrative costs and increase compliance in company-wide policy and procedure changes. Examples include sales, service, and fulfillment processes; financial procedures; HR benefits plans, policies and procedures; and mandatory awareness initiatives (see below).

Mandatory Awareness Initiatives

Some policy awareness programs are a strategic priority due to potentially high litigation exposure. Some examples are sexual harassment, diversity, drug use, materials handling, mission-critical systems operation, and environment safety policies.

MECA's closed-loop action items are the superior means of ensuring that employees fully understand, acknowledge, and comply with key policies. MECA can manage policy acknowledgment via digital media, voice-print, and signed paper forms. MECA also reports in real-time the number of employees affected by a policy, and the exact percentage who have received, acknowledged, and demonstrated understanding of the policy.

Reorganizations

Reorganizations often entail (1) re-evaluations of value contributed by various components of the organization, and (2) wholesale changes in reporting relationships, departmental mission, individual roles, and sometimes head-count. MECA accelerates both phases: first, MECA maps roles, performance, and other profile information across the organization. Simple action items can be deployed to add any number of “overlays” to that organizational map; second, once the re-organization plan has been drafted, MECA Actions coordinate plan execution by targeting, notifying, directing, and training employees and middle management, and tracking progress for senior management.

Product Roll-Outs

MECA can be used to manage Actions such as product rollouts and marketing campaigns. MECA provides the tightly synchronized notifications, directives, and targeted training for sales, service, and fulfillment staff.

Unlike traditional communications methods. MECA delivers aggressive, closed-loop management of every action item and every individual Action participant. Senior management receive precise progress data right up to the launch date.

IT System Implementations

MECA can be used to centrally and systematically manage the communications, training, feedback collection, and other components of any complex transition to an enterprise application. MECA can be used to track progress versus readiness objectives prior to “throwing the switch.”

MECA in Action—Key Concepts

The technology. In one embodiment, the MECA action management platform is a hosted extranet and computer telephony application. A client's MECA implementation runs on a collection of industrial database, application, and telephony servers in an ultra-secure data center. MECA communicates with the client's users via a dedicated VPN or WAN gateway and the public switched telephone system. (a customer could choose never to see MECA's physical implementation.)

In effect, MECA is the client's “virtual infrastructure” for creating, deploying, and executing large-scale and complex initiatives. Once an initiative is deployed, MECA will directly initiate, facilitate, and follow-up on thousands of interdependent action items. MECA interacts with users via e-mail, the Web, voice-response, fax, pagers, and other media. When needed, MECA communicates with participants via human intermediaries, in the Action Support Centers.

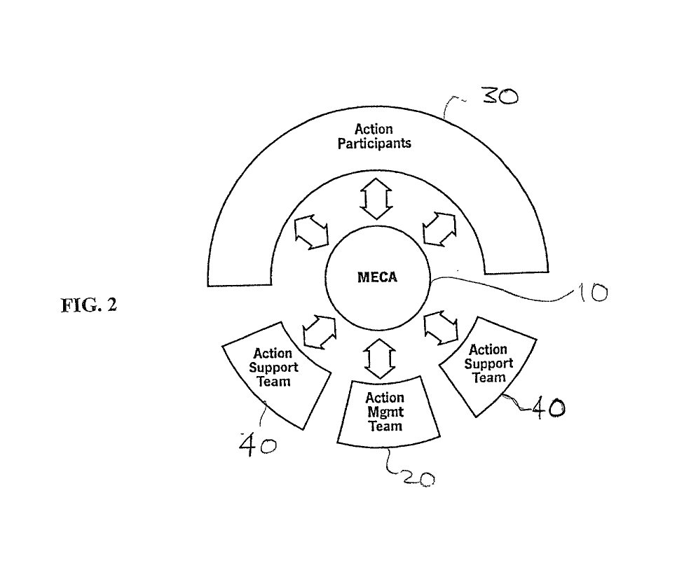

Business users. MECA users include Action Management Teams, specialized Action Support Teams, and hundreds or thousands of Action participants. The Action Management Team defines and deploys Actions on MECA. FIG. 2 is a diagram that illustrates the interaction between MECA's action management platform 10, the action management team 20, the action participants 30, and the action support team 40.

Actions. MECA Actions are multi-stage business processes built from many interconnected, agent-like action items. An Action may involve thousands of action item execution cycles, all managed by MECA. In general, an Action corresponds to a client initiative, or a major project within an initiative.

Action items. The action item is the atomic unit of Action in MECA. action items may appear to participants as questionnaires, instructions to perform a complex task, interactive training materials, or simple communications that require some kind of acknowledgement. The variety of action Items is infinite, yet all action Items in MECA fall within six exemplary “building-block” types: notifications, queries, data forms, directives, transfers of knowledge, and role/responsibility assignments. action items are delivered and performed in a closed-loop “execution cycle:

An action item's execution cycle can include a variety of steps, such as initial notification of the action item to perform, escalation if there is no response, presentation of the action item when the participant is ready, re-assignment of responsibility for the action item if the participant cannot or should not perform it, performance or execution of the action item, and triggering new action Items based on previous action item outcomes.

Interacting with MECA. MECA interactions include notifications of action items to perform, action item responses or updates, and reporting.

MECA can pro-actively initiate these interactions by presenting them either electronically (via e-mail, interactive Web forms, voice prompts, etc.), or via action support team 40 facilitators. Similarly, action participants 30 can initiate, perform, or update action Items by either electronic or traditional communications.

Action Support Teams. Action support teams 40 provide communications and logistics support. Examples include Action Help Desk; out-bound calling (notifications, reminders, status checks, and employee surveys); data entry; printing and shipping.

Implementing MECA. The present invention contemplates providing all of the services necessary for rapid implementation and successful action management with MECA. Such services include: MECA application hosting; implementation, integration, and data migration; business process analysis, action design (or planning) assistance, and action Item content development; action support teams; user training, and customer support.

MECA Users and Roles

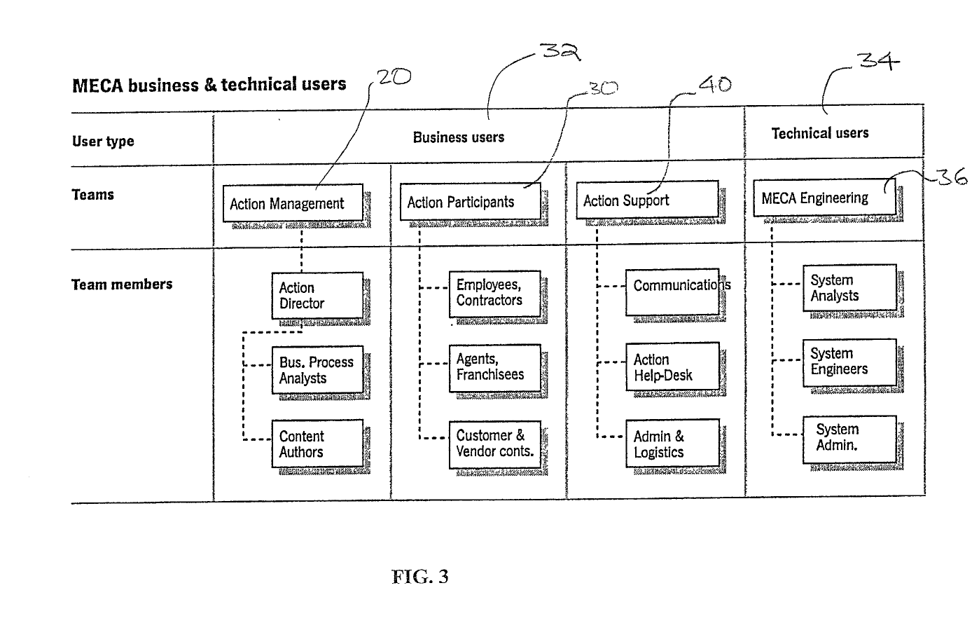

As shown in FIG. 3, there are two general user categories: technical business users 32 and technical users 34. Technical users consist of MECA Engineering Teams. Business users come from both MECA provider and the customer organization and help provide the functionality associated with the action management teams 20, the action participants 30, and the action support teams 40.

MECA Engineering Teams

MECA engineering team 36 include MECA System Analysts, System Engineers, and System Administrators. Though not generally dedicated to specific actions or initiatives, some may be dedicated to particular customers. The role of the engineering team 36 is to ensure, that MECA Actions support their business objectives from design through deployment.

Business Users

Three categories of business users 32 work with MECA. (1) Action management teams 20 define and deploy actions and action Items. Composed of customer and MECA provider team members. Team size typically may range from ten to fifty members, for example. (2) Action participants 30 perform action items. Normally customer members. An action typically may have from a hundred to several thousand participants. (3) Action Support Teams 40. Facilitate or participate in actions. An action may typically involve from one to five specialized teams, each ranging from five to twenty five members.

Action Management Teams

Action management teams 20 may typically be composed of: (1) Action directors (AD) who define an action in business terms: desired outcomes, time-frames, conditions, parameters, success measures. Responsible for the business objectives of the Action. Action Directors are customer team members. (2) Business process teams (BP) who translate the business objectives into a process. Defines the action as a network of action items. Customer and MECA provider typically provide team members. (3) Content authors develop interactive action item content. Can include subject-matter experts, writers, HTML authors, multimedia designers, illustrators and voice-over artists. Typically includes mostly MECA provider team members with customer subject matter experts.

Action Participants

Action participants 30 are generally employees of the customer, but may also include the customer's vendor contacts, agents, franchisees, contractors, and even action support team 40 members (see below and next section).

Action participants 30 receive notifications from MECA via electronic or print media, or personal contact by Action Support Teams 40. Participants act on the notifications via Web and other interactive communications media, or by contacting an Action Support Team 40.

Action Support Teams

Action Support Centers/Teams 40 are dedicated, centralized resource pools for administrative, communications, and logistics support. Action support is outlined in greater detail in the following pages.

Action Support

In one aspect, MECA addresses the human dimension of action management is by integrating live, dedicated support resources in the action item execution cycle. These resources are Action Support Teams 40.

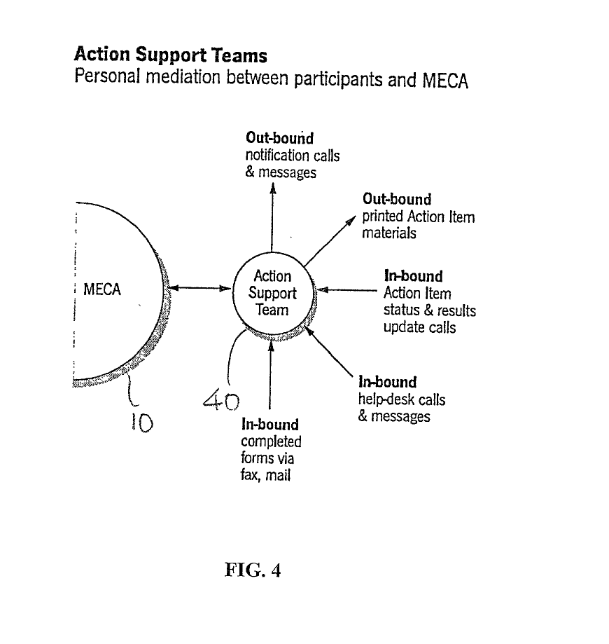

As shown in FIG. 4, action support teams 40 are dedicated, centralized resource pools for administrative, communications, and logistics support that communicates with the MECA action management platform 10 and sends and receives communications from action participants 30. Support Teams may be mobilized and trained on-demand to support specific customer actions

Support Teams receive incoming workflow in the form of calls, e-mail, or materials from participants, and action items or instructions from MECA. Action Support Teams facilitate action in four ways: (1) Communication. Support teams serve as live intermediaries for communications initiated by both action participants 30 (in-bound) and by MECA 10 (out-bound). (2) Participation. Support teams 40 can perform many action Items just as any other action participant. (3) Help Desk. Support teams 40 provide help-desk support specific to the action underway. (4) Administration. Support teams perform administrative, production, or logistical tasks in support of actions.

Communication

In bound communication support. Personal intermediaries may be needed for a variety of reasons. For example, many action participants 30 may not have Web access at the time they need to update an action item.

Participants can simply call a support center, where a team member can take the action item information from the participant and enter it directly into MECA. The support team 40 member could also have the action Item materials produced in another format (such as print or fax) and have it delivered to the participant. These are examples of “in-bound” communication support.

Out-bound communication support. Action support teams 40 can also provide pro-active, out-bound communication support. An example is notification escalation. For an urgent or key action item, rather than send repeated e-mail messages, the notification sequence may escalate to a phone call (i.e., a different communication media is used) from a support team 40 member.

Certain participant groups may not have electronic notification channels at all, in which case every notification can be delivered by support team 40 staff—at a rate, for example, of hundreds of calls per hour.

MECA can be programmed to instruct a support team member 40 to personally apprise a management team member of critical status changes during the course of an action.

Direct Participation in Actions

Certain actions include action Items that do not necessarily have to be performed by the customer's employees, and can actually be performed instead by action support teams 40.

In fact, a temporarily dedicated support team 40 can perform certain action items more efficiently, more consistently, and more cost-effectively than is normally possible with employees or other entities such as vendors. A few examples of such action items include: status queries, follow-up calls, and surveys of employees, vendors, agents, or other action participants.

Help Desk

Action participants 30 can call an Action Support Center 40 for further explanation of the action item. Action support staff can view the action item in question, answer questions, or put the participant in contact with the appropriate action management team member who can address the question.

When interacting with MECA via telephone auto-attendant, participants may enter a key such as “0” to connect to an Action Support Team 40 member for live assistance.

Administration

Administrative and production support centers perform scanning and archiving of incoming forms, data entry, and printing and fulfillment of requested action item materials.

Customer Benefits of Action Support

Action support teams 40 can be instrumental in the smooth execution of an otherwise difficult-to-manage action. Action support teams can: (1) reduce administrative burden by activating support teams 40 on demand, by eliminating the need for dedicated administrative resources in the customer's organization, and by automating and systematizing massive administrative tasks; (2) decrease management burden by off-loading many managerial communications responsibilities such as notification, employee education, follow-up, and reporting; (3) increase compliance by providing assistance, by allowing participants to complete action Items by telephone, and by pro-actively and personally notifying participants of action items, when desired; and (4) shorten action cycles by performing certain action items, by personally notifying participants of action items, and by eliminating administrative bottlenecks in the action sequence.

Actions

An action (or initiative) is a large-scale effort such as launching a product, or migrating an acquired company's policies and procedures to those of the acquiring company. Actions are deployed on and managed via MECA. To deploy an Action on MECA, the action is first defined as a special type of business process. This business process consists of series of building-block events or tasks to be performed by action participants and by MECA. The primary building block events are called action Items (discussed further in the next section).

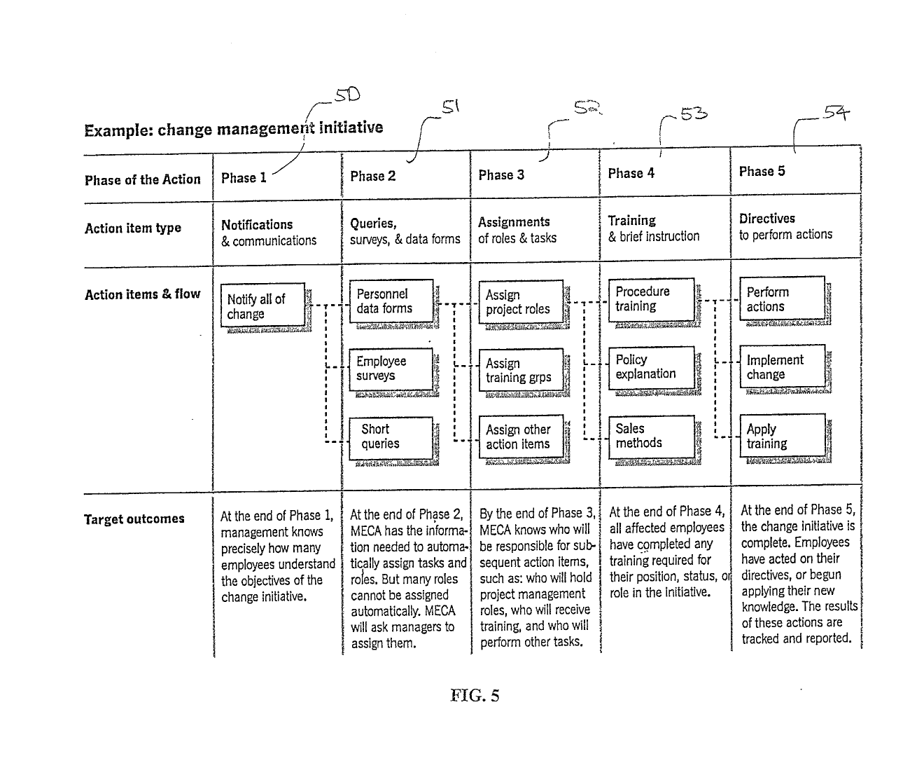

Example: change management initiative. FIG. 5 depicts the phases of a generic, MECA-assisted change-management. The idealized initiative unfolds in five-phases 50-54: In the first phase 50, MECA notifies affected employees. In the second phase 51, MECA collects information from employees. In the third phase 52, MECA uses the information to assign project roles, training requirements, and other action items. In the fourth phase 53, MECA manages execution of a training and explanation phase. Finally, in the fifth phase 54, MECA directs the application of the training by providing directives to perform the actions in accordance with the assigned action items.

For illustrative purposes in FIG. 5, each “phase” includes only one primary action item type. Real actions (or initiatives) may have many simultaneous, different action item types deployed in any order consistent with the business requirements. Second, an action may not have discrete phases at all. MECA provides the capability for action item timing to be as tightly or loosely coupled to other action items as necessary.

Action Items

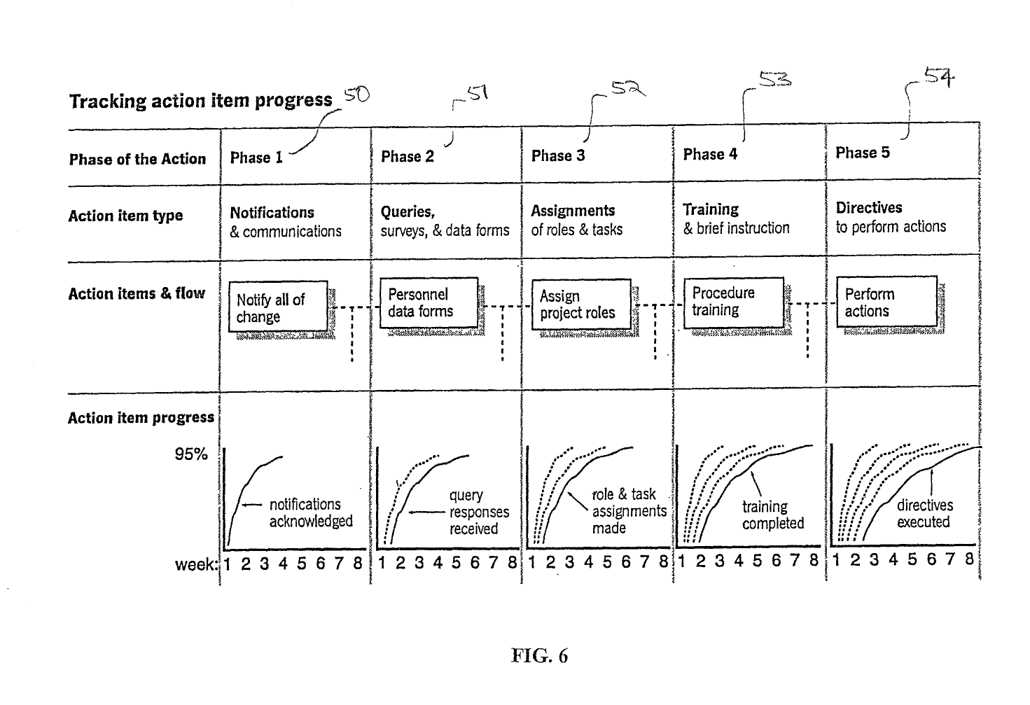

Action item types. FIG. 6 is a diagram illustrates tracking the progress of action item in phases 50-54. Exemplary primary action item types are: notifications; queries, surveys, and data forms; directives; training units; assignment or delegation.

The last type of action item plays a special role. Assignments are action items which require managers to assign roles or tasks to other action participants.

Action items in MECA may be presented to the participant as, or delivered via various media, such as: e-mail forms; web page links; automated telephone voice-prompts; verbally, by action support team members; faxes or printed and bound materials; and by US Mail, UPS, FedEX, etc.

An action participant may begin an action item in one medium and continue it in others until completed. Typically, each action item includes: any necessary background information; instructions on how to perform the action item; a way to capture results (e.g. Web form); and links and contact information for help.

The action item execution cycle, from targeting or assignment through completion, is detailed in the following paragraphs.

The Action Item Execution Cycle

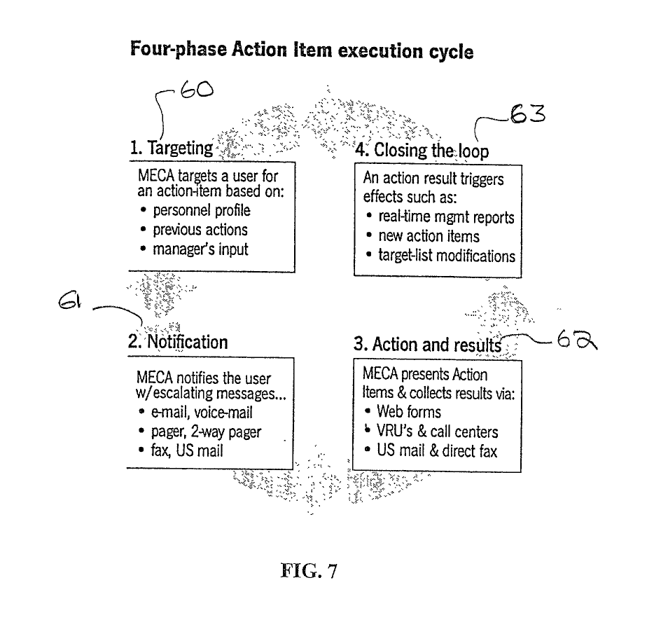

MECA actively manages the delivery and performance of every action item in a closed-loop cycle, with four primary stages 60-63 as illustrated in FIG. 7.

In stage 60 (Targeting), MECA dynamically identifies individual action participants. Thousands of action participants can be targeted automatically, at any time during an action. Targeting is based on a variety of data sources including a self-maintaining “map” or “organizational model” of roles and capabilities in the organization. MECA begins constructing this map itself, as soon as the system is turned up.

In stage 61 (Notification), MECA provides each participant with repeated, escalating notification of the action Items to perform. MECA notifies Action participants by sending short messages via e-mail, pager, HTTP, voice-mail, or other communications media based on individual user preferences. Notifications can escalate across communications media, and from the action participant to supervisors and others, based on action role definitions. A notification message always provides a link (such as a Web hyperlink, or a telephone number) that will lead the action participant to the action item.

In stage 62 (action item presentation and performance), MECA interactively guides the performance of action items by every action participant. MECA first presents the information required to perform the action Item, collects the results or response, and provides links to help.

Presentation and performance may sometimes happen in single interaction with MECA—for example, by simply reading and completing an on-line survey form.

Often the action participant will be instructed to perform some task outside the system—such as evaluating another employee, taking an instructor-led course, or interviewing a customer. In these cases MECA will later collect the results of the action item from the action participant—or even from another person, such as the course instructor.

In stage 63 (closing the loop), MECA uses the results of action items to update reports, and to trigger other action items in succession (or to change the target lists of other action items) until the overall action is complete.

For example, an action item may instruct one class of action participants to, in effect, create or modify portions of the target lists for other action items. This powerful technique permits MECA to dynamically create chains-of command without advance knowledge of exactly who every action participant will be. MECA also generates report of action progress, status, and consolidated results.

Accelerated Implementation (Implementing MECA)

MECA is designed to be implemented in a fraction of the time required by other enterprise solutions such as CRM or ERP. Some of the reasons for this are:

Phased implementation. Unlike information systems used for more typically routine operations (finance, HR, CRM, ERP, etc.) MECA is not an all—or nothing proposition. MECA can first be implemented on a relatively modest scale and then expanded to more diverse action management applications.

Low integration requirements. Similarly, MECA is designed to be fully functional with little or no direct integration with the customer's information systems (such as HR IS). Tighter integration with customer MIS resources can be phased in later if required for performance or flexibility.

Full service. The present invention contemplates providing or managing all services required for implementation, overall action design, and action item development and authoring.

Hosted application. Because the present invention contemplates operating the platform in secure data centers, MECA requires no customer premises equipment (CPE). A new system can be quickly “cloned” right in the hosting center.

No new infrastructure. MECA typically requires no new infrastructure, and no new software for the customer's employee users.

Post-Acquisition Integration (One Exemplary Application for MECA)

Another exemplary application for MECA is in post-merger/acquisition integration. This market is suitable for MECA for at least six reasons: acute need, high buyer urgency, lack of alternative solutions, integration budgets, large market size, and high marketing value.

Acute need. Following an acquisition, the needs that MECA is designed to fill are at their most acute. The acquiring organization may need to simultaneously . . .

Consolidate lines of business, quality standards, sales practices, reporting lines, etc.

Communicate and enforce hundreds of policy changes in the acquired company

Implement hundreds of procedural changes and dozens of IT transitions

Need for speed. Acquiring companies know what studies have repeatedly shown: that the best predictor of success is integration speed, and the most expensive integration is a slow one. This plays to MECA's value proposition, which is accelerated strategic change.

Lack of alternatives. There are in fact no visible alternatives to MECA on the market. Companies manage integration by traditional, chain-of-command, and/or with extremely costly consulting engagements—which, when completed, may leave behind no structural asset comparable to MECA.

Budget. An acquisition is a planned, budgeted action designed to capture an opportunity and that, by definition, the acquiring company can afford. This is in contrast with many gradual-onset challenges that companies may struggle with for years.

Huge market. The rate of acquisitions and the average deal size have been increasing since the early nineties. In 1998 alone there were 9,149 acquisitions involving American companies, in transactions totaling $1.3 trillion. Of the 3,955 deals for which prices were revealed, almost half were over $50 million, and 1,249 were greater than $100 million.

Marketing value. The odds against successful integration (as measured by change in shareholder value) have become common knowledge. Also, success in post-integration actions will validate MECA for other enterprise actions.

MECA Software Design Overview

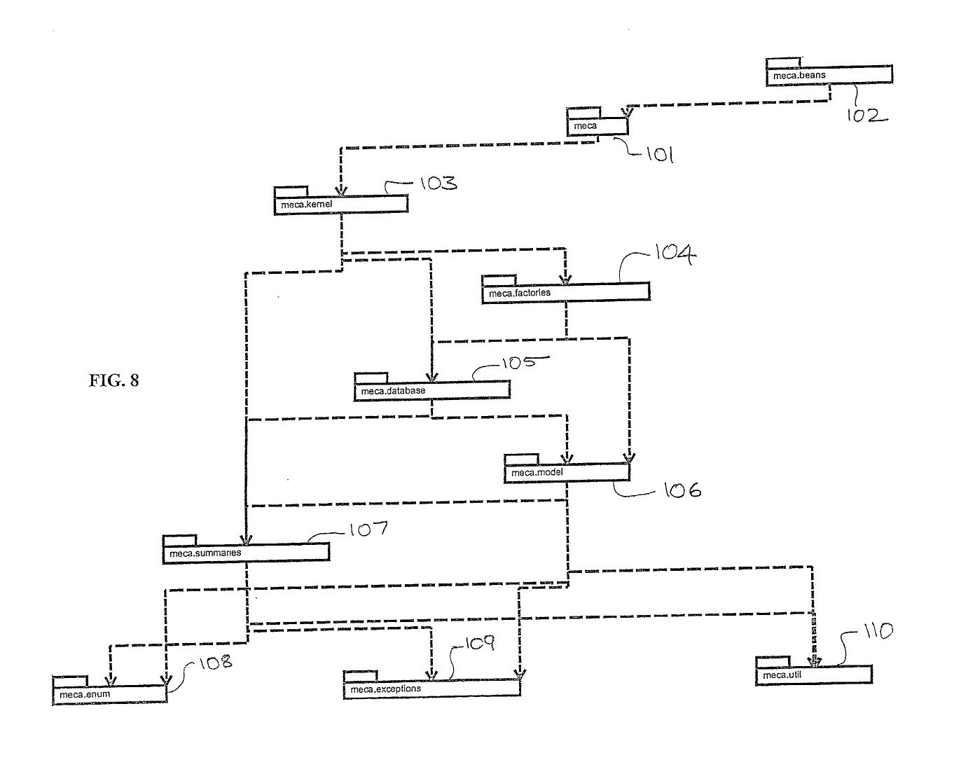

The following sections discuss one software based implementation of some of the core aspects of MECA. One skilled in the art would recognize that many other implementations are within the abilities of one skilled in the art based on the description herein and all such implementations are considered within the scope of the present invention as described in the present specification and figures. The software design overview of the presented herein is discussed in conjunction with FIGS. 8-17.

1. Program/Package Structure

In one embodiment, MECA is implemented as a Java application which is divided into a number of Java packages encapsulating major functional areas. The following is a summary of each. FIG. 8 is a program/package structure diagram according one implementation of the present invention.

meca 101—Classes for managing Java Remote Method Interface communications between the MECA server and clients.

meca.beans 102—Classes for requesting MECA data from the server and presenting it to clients in web pages.

meca.kernel 103—Classes for processing client requests to access and modify data, and for generating/handling the internal MECA events triggered by modifications.

meca.factories 104—Classes for translating data from client-centered “summary form” to the internal MECA representations.

meca.database 105—Classes for managing storage and retrieval of MECA objects on disk.

meca.model 106—Classes representing MECA business model objects.

meca.summaries 107—Classes for representing the objects in

meca.model 106 in client-centered “summary form”; essentially views into the model data tailored for specific client actions.

meca.enum 108—Classes for representing enumerated types in the MECA server.

meca.exceptions 109—Classes for representing exceptional or erroneous conditions in the MECA server.

meca.util 110—Generally useful utility classes shared across all packages.

FIG. 8 also illustrates the dependencies among these packages.

2. Essential MECA Function

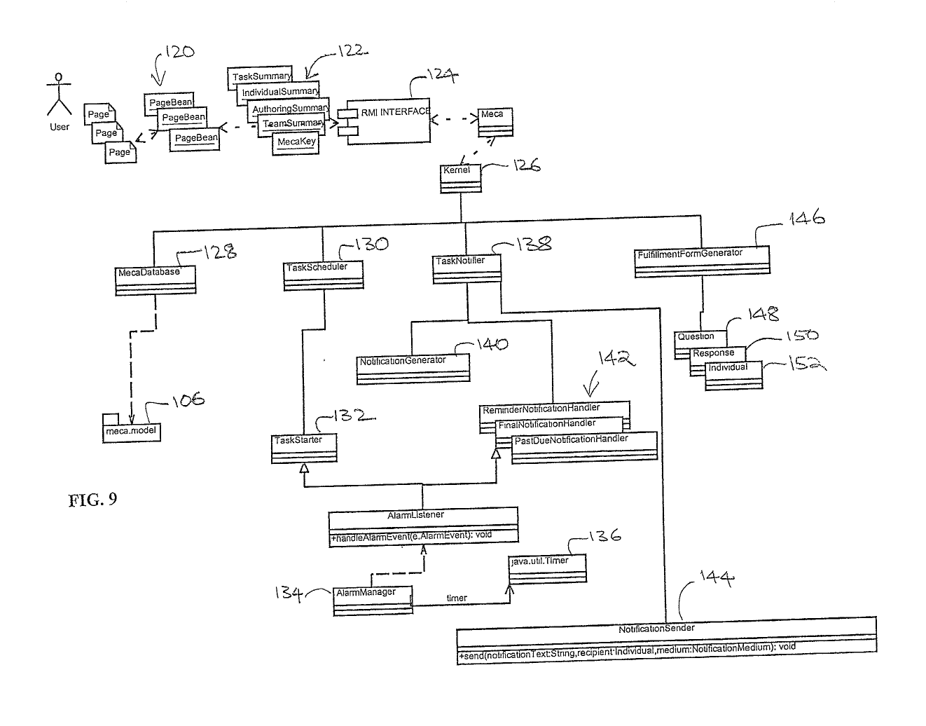

FIG. 9 is an exemplary MECA Architecture Diagram that illustrates exemplary classes used in one implementation of the present invention.

All users interact with MECA via web pages, which are generated by Java Server Page technology, supported by a number of classes derived from PageinterfaceBean 120. These Java beans make use of the TaskSummary, IndividualSummary, AuthoringSummary, TeamSummary, and MecaKey classes (collectively 122), which are views of the model data tailored to specific pages and page actions. These classes are sent and retrieved by the server portion of the system via a Java RMI Interface 124 which is implemented by the Mecalmpl class running in the server process. This class dispatches calls to various functions in the Kernel class 126, which serves as the main nerve center in MECA, with five basic functions:

(1) Saving and retrieving data securely to disk, in cooperation with the MecaDatabase object 128 and the meca.model 106 package.

(2) Scheduling and monitoring the progress of Task objects, in cooperation with the TaskScheduler object 130. The TaskScheduler 130 monitors changes to Task data in response to data modification requests from clients, and sets timers in the AlarmManager object 134 if the system has reached such a point that the start dates for any Tasks are known. These alarms are handled by the TaskStarter object 132, which updates the data structures and kick-starts the processes required to monitor the progress and ultimate completion of the task. The AlarmManager 134 simply wraps a Java Timer object 136, but allows for running MECA in a simulated-time mode for testing purposes.

(3) Notifying users that tasks which they must attend to have begun, reminding them that tasks are ongoing but that their contribution to the task is not yet fulfilled, warning them that task due dates are imminent or passed, and carbon-copying selected higher-ups that progress is not being made speedily. This is all done in cooperation with the TaskNotifier class 138, which again makes use of the aforementioned AlarmManager 134 to schedule these notifications, as well as the NotificationGenerator class 140, which actually produces the desired notification in the medium appropriate for the urgency of the message. (The MECA design currently anticipates notifications by email, pager, cell phone, PDA, etc.) Alarms which go off are handled by one of ReminderNotificationHandler, FinalNotificationHandler, and PastDueNotificationHandler (collectively 142), depending on the stage of the task in question. Notifications are sent via the NotificationSender 144, which considers the medium of the message and any supervisory individuals who may be interested in the task's progress, queues notification requests, and uses the appropriate messaging protocols to have the notifications sent in a low-priority background thread which the rest of MECA continues running.

(4) Allowing users to fulfill their responsibilities to the task, in cooperation with the FulfilmentFormGenerator class 146. User responsibilities to tasks in MECA are represented by Question objects 148, or individual pieces of data which the user must supply. The collection of Question objects associated with a task represent his entire responsibility for it, and when a user who has been notified of his responsibility to a task logs on to MECA and goes to the appropriate section, he is presented with a web page containing interactive controls for each Question, along with some introductory/explanatory text describing the task and prompting him to respond correctly. The selections and entries made into this form are collected by a Java servlet into Response objects 150, which ensure the well-formedness of typed responses such as numbers, phone numbers, email addresses, etc., type them appropriately, and store them in a form cross-referenced to the Individual object 152 representing the responder and the Question object he was responding to. A Task becomes “complete” when all assigned responders have satisfactorily supplied the data requested; what constitutes a satisfactory set of responses to a Task is configurable.

(5) (Not shown on diagram) Allowing privileged users to create new tasks; specify the Questions required for the task and their associated ResponseTypes; specify which Individuals are responsible for answering the questions; define what NotificationSchedule to use in keeping users abreast of the state and progress of the task; select which FormComlpetenessMetric to use to determine when a responder's responses satisfy his responsibility to the task; and select which TaskCompletenessMetric to use to determine when a task is fully complete and may cease to run.

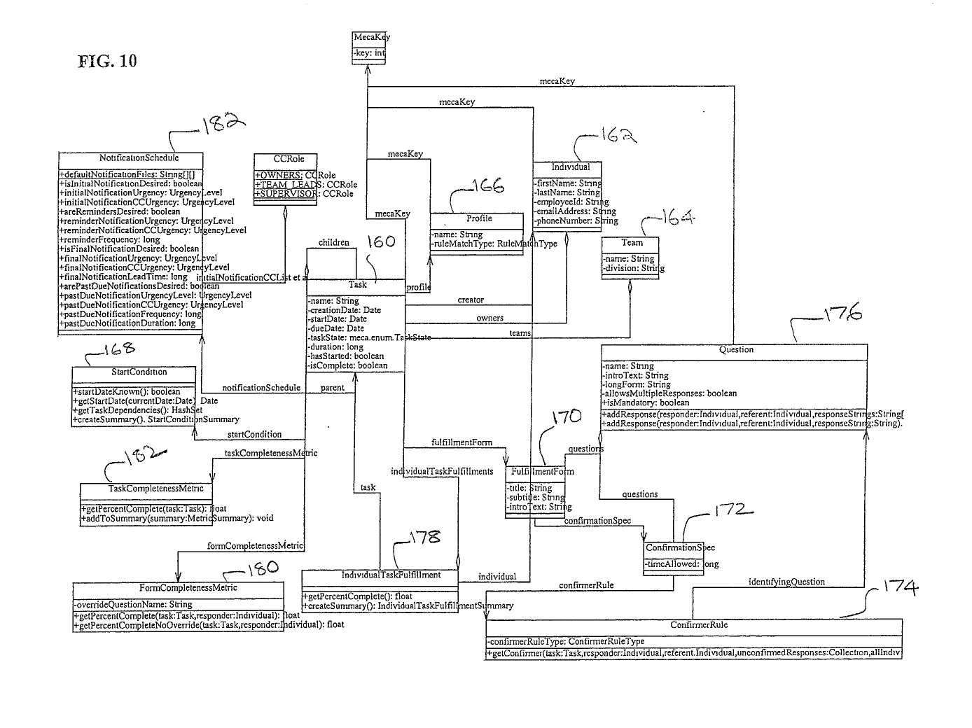

FIGS. 10-18 provide additional details of the some the classes referenced earlier herein.

3. Overview of Task Class (See FIG. 10)

FIG. 10 is class diagram illustrating the relationships of the Task class 160. As MECA is largely a system for managing tasks, the Task class 160 serves as the main data model class for tying MECA data together. It contains a number of attributes for identifying the task; indicating how and when it was created; when it began and when it is due, if it has begun; and its current state, which may be one of TaskState.DRAFT (meaning the task is not fully formed and will not start or accept fulfillment, even if its time comes), TaskState.ACTIVE (meaning that the task is ready to be started or has started and is accepting fulfillments), TaskState.SUSPENDED (meaning that the task is down for maintenance and not accepting fulfillments), TaskState.COMPLETE (meaning that the task has satisfied its data collection requirements and no further fulfillments or changes are accepted), or TaskState.KILLED (meaning that the task should simply be removed from the processing loop for good).

In one embodiment, a task may have exactly one parent task but any number of children. The children, or subtasks, may determine whether a task is complete or not.

Also associated with the Task class 160 are the following:

(1) a collection of Individual objects 162, representing the “owners” of the task—that is, the people who provide oversight of the task. These people can view the task state and all responses made to it, and can optionally be CC'ed when the task is nearing the due date without completion or is late. Similarly, the task is associated with a collection of Team objects, which fulfill a similar oversight role; in this case all members of the team have owner-like access to the task.

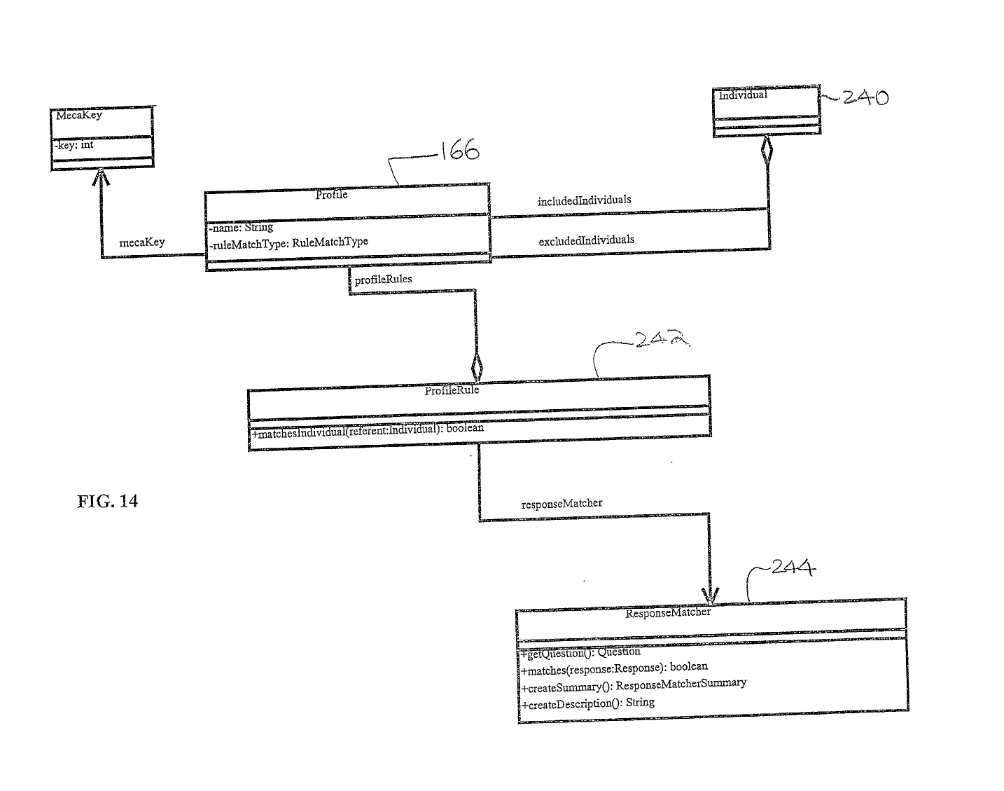

(2) one Profile object 166, which specifies the individuals responsible for fulfilling the task by responding to questions. These individuals can be specified by roster, or by “rules” which look for matches to attributes of all individuals in the system, such as management level, supervisor, division, age, or responses made to Questions 176 in other Tasks 160. See FIG. 14 for greater details.

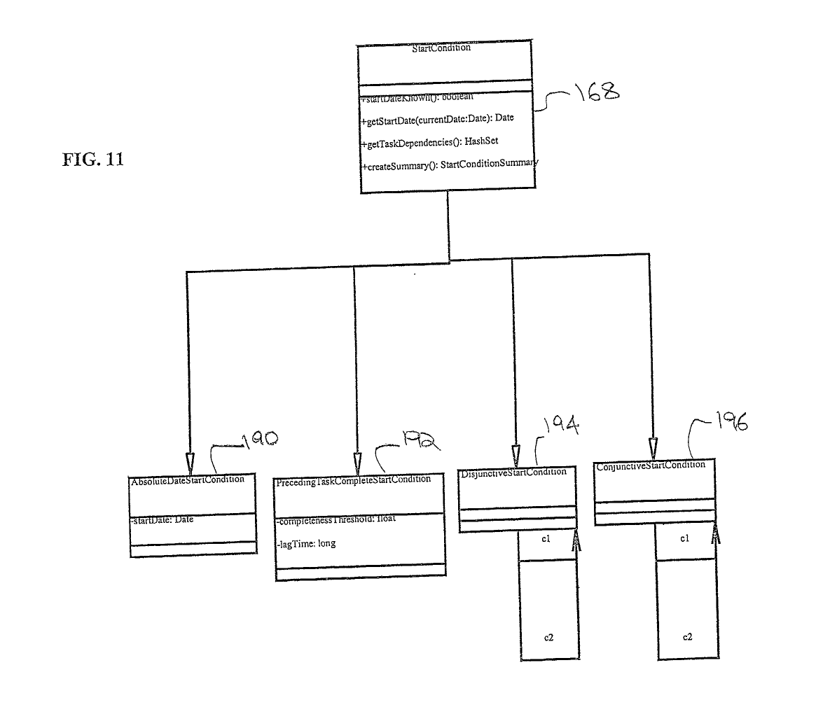

(3) one StartCondition object 168, which specifies when the task should start. Task start times need not be absolute dates; they may depend on the completeness of other tasks or a combination of these. The classes derived from StartCondition all can indicate whether the start date is known or not (it may not be known until other tasks have ended), and if so, when the task should start. This information is used for scheduling. See FIG. 11 for more information.

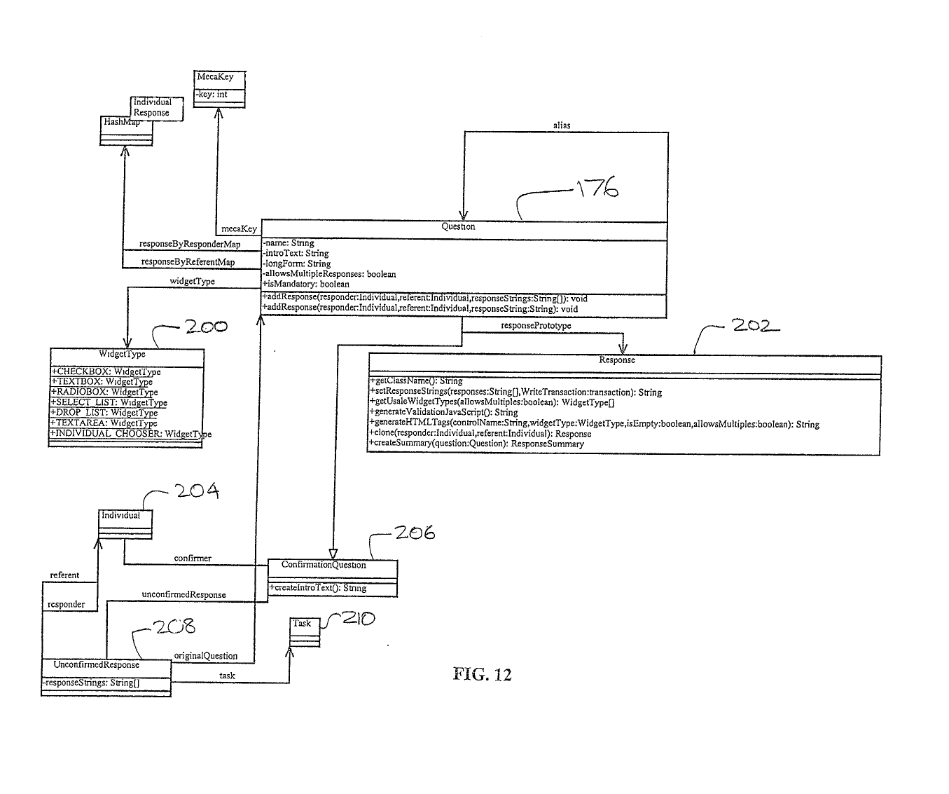

(4) one FulfillmentForm object 170, which represents the information presented to the user describing his responsibility to the task and the set of Questions he must answer to fulfill his responsibility. Some questions in the form may be subject to confirmation; that is, they must be sent to another individual for verification before they are written to the database as final. One ConfirmationSpec object 172 is optionally associated with the FulfillmentForm object 170 to indicate the non-empty set of questions requiring confirmation, as well as one ConfirmerRule object 174 specifying who should confirm. This may be someone who fulfills a role with respect to the responder, in which case the ConfirmerRule 174 has a ConfirmerRole object associated; or this may be the person identified in some question in the form itself, in which case the ConfirmerRule has a single question with an IndividualResponse associated. See FIG. 12 for more details.

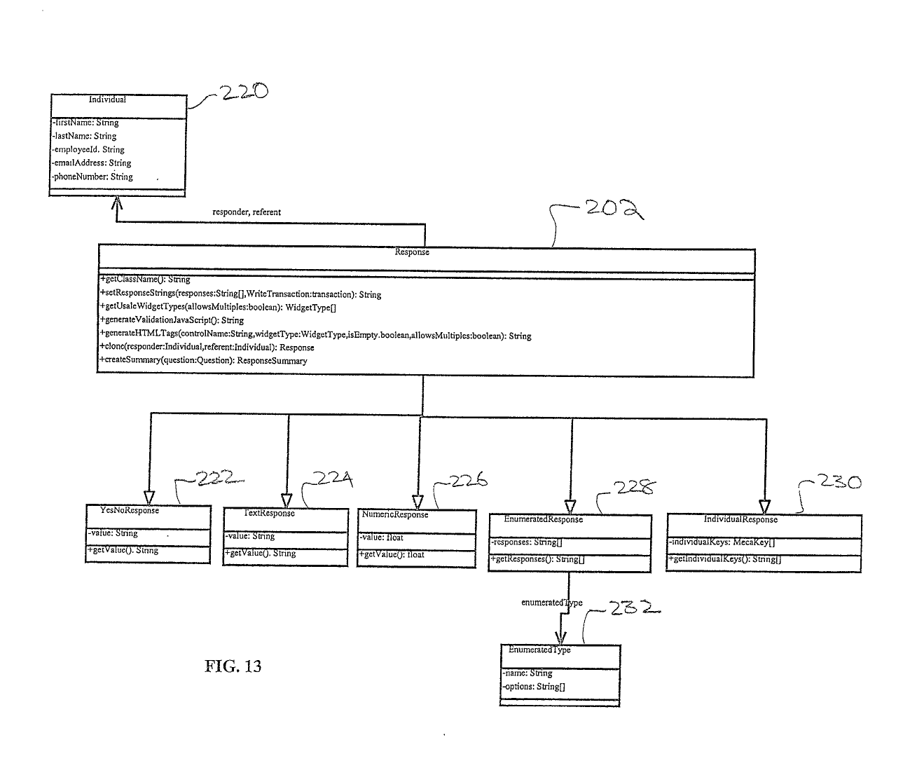

(5) a set of IndividualTaskFulfillment objects 178, one for each individual currently matching the task's Profile 166. Each object represents the associated individual's progress in fulfilling his responsibility to the task. As he answers more questions, his percent-complete measure for the task may rise, and eventually reach 100%. See FIG. 13 for more details.

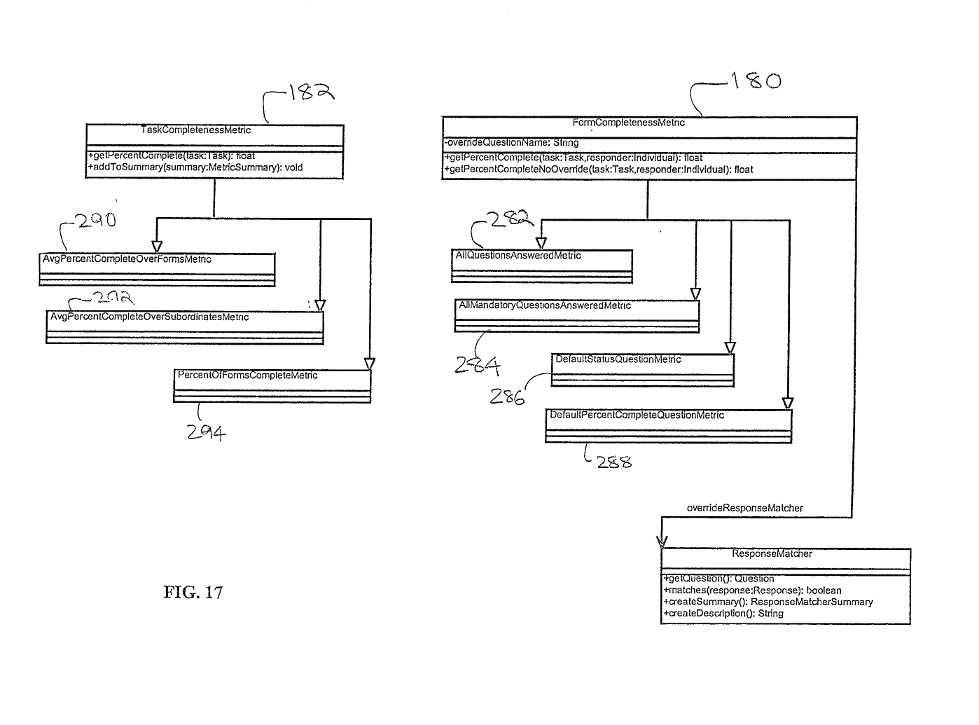

(6) one FormCompletenessMetric object 180, describing the rule to use to determine when an individual has completed his form and thus fulfilled his responsibility to the task. See FIG. 17 for more details.

(7) one TaskCompletenessMetric object 182, describing the rule to use to determined when the task is fully complete. See FIG. 17 for more details.

(8) one NotificationSchedule object 182, describing what messages should go out to whom to keep users of MECA informed of the progress of tasks they oversee or must perform. There are four notification stages—an initial stage, to notify individuals matching the task's Profile that they are responsible for the task; a reminder stage, to notify, with some periodicity, those individuals who are not complete that the task is still ongoing; a final stage, to notify those individuals who are not complete that the task is within some tolerance of being due; and a past-due stage, to notify with some periodicity and for some finite duration those individuals who are not complete that the task has passed its due date. At each stage a notification may optionally be sent out with some “urgency” level. Each individual may specify how he wishes to be contacted at each urgency level—via email, pager, or telephone. Optionally, supervisory individuals, team leads, or task owners may be CC'ed on any of these notifications, at their own urgency levels, to provide oversight.

4. Overview of StartCondition Class (See FIG. 11)

FIG. 11 is an UML diagram that provides an overview of he StartCondition class 168. The StartCondition class 168 serves as the base class for four specific types of task start conditions.

An AbsoluteStartCondition object 190 indicates that a task should start on a fixed date. Thus a task with this start condition may be put in the schedule immediately, to begin at that date.

A PrecedingTaskCompleteStartCondition object 192 indicates that a task should start when another task has reached a certain level of completion, plus an optional amount of lag time. (Typically this will be 100% and 0, respectively.) Thus a task with this start condition may not be scheduled until the preceding task has actually reached that level of completeness.

A DisjunctiveStartCondition object 194 indicates that either of two conditions, whichever is earlier, must be met before the task can begin. The two conditions may be any type of start condition. The task may not be scheduled until either start date is known.

A ConjunctiveStartCondition object 196 indicates that both of two conditions must be met before the task can begin. The task may not be scheduled until both start dates are known, and the latter is used.

5. Overview of the Question Class (See FIG. 12)

FIG. 12 is an UML diagram providing an overview of the Question class 176. The Question class 176 represents a piece of data requested from a responder to a task. It has a mnemonic name, optional explanatory or introductory text, a “long form” or non-optional text prompting the user to respond, and may allow multiple responses. Questions marked as mandatory cannot have blank answers.

A Question object 176 is associated with the following:

(1) One WidgetType object 200, describing the type of control to render in the web page for the user's selection.

(2) One Response object 202, serving as a prototype response to the question. The type of the derived class of this prototype determines what type of response is allowed. See FIG. 13 for more details of the Response object 202.

(3) A one-to-one mapping from Individual objects 204 to Response objects 202, indicating for each question which responses have been made by which responders so far.

The Question class has one subclass, the ConfirmationQuestion. 206. These objects are created when a responder answers a question which is marked in a FulfillmentForm 170 as requiring confirmation. Any response to a question requiring confirmation is stored first as an UnconfirmedResponse 208 and stored along with a ConfirmationQuestion 206 generated for the Question/Individual/Individual triple of question, responder, and confirmer. All ConfirmationQuestions are collected on an ongoing basis for the associated Task 160 and presented to the confirmer as part of a newly created “confirmation” task 210 he may accept or reject the UnconfirmedResponses. Rejected responses are sent back to the original responder in another newly created “redo” task, and this cycle may iterate until the responses are accepted.

6. Overview of Response Class and Subclasses (See FIG. 13)

FIG. 13 is a UML diagram illustrating the Response Class 202. The Response class 202 represents data entered by an individual responsible for a task in response to a Question 176 in that task. Response 202 is actually the abstract base class of a number of type-specific classes. Each subclass must have a class name, and be able to supply its response information in the form of an array of strings (an array because responses may be multiple for a single question). Each must also indicate which WidgetTypes are capable of collecting the response, and must be able to generate JavaScript code to verify text or selections made in those widgets. Each must be able to generate HTML to produce the widget and any other tags required for that part of the page to function. Each must also be able to clone a new, empty instance, and then allow this empty instance to be filled with data represented as an array of strings.

A Response object 202 is associated with the following:

(1) One Individual object 220, representing the individual who made the response.

(2) One Individual object 220, representing the referent of the response, that is, the individual whom the response concerns. For example, in the case of a ConfirmationQuestion, the responder (who is confirming responses) to a question may not match the referent of his response (who is the individual who made the response in the first place). The confirmer is answering questions about another individual.

The subclasses of Response are:

(1) YesNoResponse 222 which allows users to choose “Yes” or “No” from a drop list.

(2) TextResponse 224 which allows users to enter a string or a list of strings.

(3) NumericResponse 226 which allows users to enter a number of list of numbers; data is stored as floats.

(4) EnumeratedResponse 228 which allows users to select a token or set of tokens from a list of preset values. An enumerated response is associated with one EnumeratedType 232 which consists of a type name and a non-empty array of string options. The strings and type names are all arbitrary and can be specified by the author of the task when he creates it.

(5) IndividualResponse 230 which allows users to select a person or set of people from all the individuals known in the MECA database; data is stored as an array of the MecaKeys of the individuals.

7. Overview of the Profile Class (See FIG. 14)

FIG. 14 is an UML diagram illustrating the Profile class 166. The Profile class 166 represents the set of Individuals 240 responsible for fulfilling a task. These individuals can be specified literally, or by virtue of matching rules targeting attributes of individuals or responses made by individuals to other tasks. If rules are specified, the Profile may be configured to RuleMatchType.MATCH_ANY (meaning that an individual who matches at least one rule is included) or RuleMatchType.MATCH_ALL (meaning that an individual is not included unless he matches all rules). Optionally the rule match type may be RuleMatchType.MATCH_EVERYONE to include everyone in the MECA database.

Associated with a Profile object 166 are:

(1) A set of Individual objects 240 indicating individuals to include in the profile literally.

(2) A set of Individual objects 240 indicating individuals to exclude from the profile, even if they match some rule.

(3) A set of ProfileRule objects 242 indicating the rules to use to determine profile membership. A ProfileRule is associated with exactly one ResponseMatcher object 244, which does the actual specification and matching. The ProfileRule object 242 can use the ResponseMatcher 244 to indicate whether an individual is included or not.

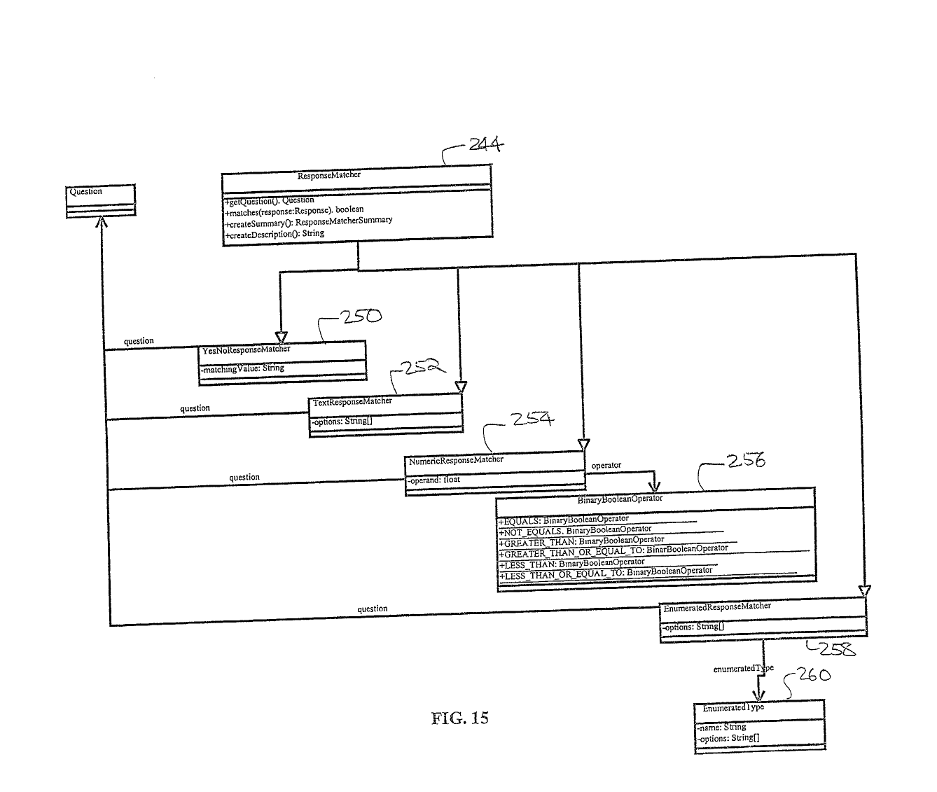

8. Overview of the ResponseMatcher Class and Subclasses (See FIG. 15)

FIG. 15 is an UML diagram that illustrates the ResponseMatcher class 244. The ResponseMatcher class 244 serves as an abstract base class for classes which can take a response and determine whether it matches some criteria, such as equaling another value, containing some token, or being less than some number. For each subclass of Response there is a subclass of ResponseMatcher. Given a response, a ResponseMatcher returns true or false depending no whether the response is a match.

Subclasses of ResponseMatcher Are:

(1) YesNoResponseMatcher 250 which matches a response if its string equals a specified value, “Yes” or “No”.

(2) TextResponseMatcher 252 which matches a response if any of the response strings equals any of an array of specified strings.

(3) NumericResponseMatcher 254 which matches a response if any of the response numbers satisfy some numeric relation to a desired operand. Associated with a NumericResponseMatcher 254 is one BinaryBooleanOperator 256 which indicates the numeric relation to use in checking for matching; these are all the binary comparator operations (equals, less than, greater than or equal to, etc).

(4) EnumeratedResponseMatcher 258 which matches a response if any of the response strings equals any of an array of specified strings. Associated with an EnumeratedResponseMatcher object is one EnumeratedType object 260, specifying the set of options which the response strings and the selected matching strings must be chosen from.

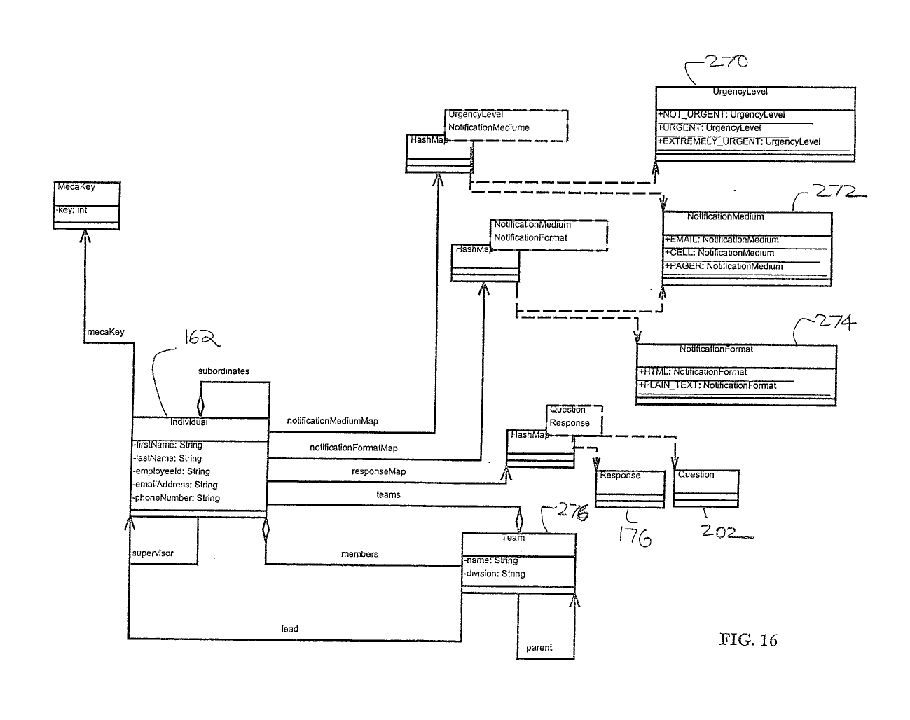

8. Overview of the Individual Class (See FIG. 16)

FIG. 16 is an UML diagram that illustrates the Individual class 162. The Individual class 162 represents information about the individuals in a business organization. Every individual must have a first and last name, an employee id, a login and password for use with MECA, and a functioning email address. Optionally the individual may also have a phone number specified. An individual may have one or no supervisor and any number of subordinates.

Associated with an Individual Object Are:

(1) A mapping from UrgencyLevel objects 270 to NotificationMedium objects 272, indicating the individual's preferred medium (email, pager, cell) for notifications at a given urgency level (not urgent, urgent, extremely urgent).

(2) A mapping from NotificationMedium objects 272 to NotificationFormat objects 274, indicating the individual's preferred format for notifications sent via a given medium.

(3) A one-to-one mapping from Question objects 176 to Response objects 202, indicating what responses refer to this individual for which questions. This is not necessarily the set of responses the individual himself made to that question; someone may have made the answer about him. Also, note that the class attributes of Individual, including last name, first name, phone number, supervisor, etc, are all stored in duplicate as responses to built-in questions. The Kernel keeps these attributes and questions in synch so that ProfileRule objects may see into the Individual member data.

(4) A set of Team objects 276 representing the teams which the individual is a member of. The Team points back to its members, and also points to the privileged team lead Individual.

9. Overview of the Completeness Metric Classes (See FIG. 17)

FIG. 17 is an UML diagram illustrating exemplary completeness metric classes. The FormCompletenessMetric class 180 represents the rule to use to determine whether an individual is done with making responses to a form, and if not, to assign him a percent-complete value to track his progress. Subclasses include:

(1) AllQuestionsAnsweredMetric 282, which evaluates completeness to 100% if an individual has made some valid response to every question in the form, but 0% otherwise.

(2) AllMandatoryQuestionsAnsweredMetric 284, which evaluates completeness to 100% if an individual has made some valid response to every mandatory question in the form, but 0% otherwise.

(3) DefaultStatusQuestionMetric 286, which requires that there be a Question in the fulfillment form called “status” whose response prototype is an EnumeratedResponse with the built in “Task Status” EnumeratedType. This class evaluates completeness to 100% only if that question's response equals “Complete”; otherwise it evaluates to 0%.

(4) DefaultPercentCompleteQuestionMetric 288, which requires that there be a Question in the fulfillment form called “percent_complete” whose response prototype is NumericResponse. This class evaluates to whatever the response made to that question was.

Associated with the FormCompletenessMetric base class 180 is:

(1) One or no ResponseMatcher object 244, representing a criterion for overriding completeness. This response matcher may be associated with a special Question in the fulfillment form who serves as a sort of “ignore everything in this form if” kind of switch. If the individual's response to that Question matches the ResponseMatcher, the form is considered 100% complete, regardless of what the subclass metric would return. Otherwise the subclass metric's value is used.

The TaskCompletenessMetric class 182 represents the rule used to determine when a Task is fully complete. The particular subclass associated with the task determines the rule.

Subclasses include:

(1) AvgPercentCompleteOverFormsMetric 290 which indicates that the completeness of the task should be the average of the completeness of all the forms of all the individuals who match the Task's Profile. If no one matches the profile, the completeness is 0%.

(2) AvgPercentCompleteOverSubordinatesMetric 292, which indicates that the completeness of the task should be the average task completeness of its subordinates. If there are no subordinates, the completeness is 0%.

(3) PercentOfFormsCompleteMetric 294, which indicates that the completeness of the task should be the percentage of forms filled out by individuals matching the Profile are complete. If no individuals match the profile, the completeness is 0%.

As would be recognized by those skilled in the art, the MECA action platform 10 can be implemented using various functional components or units implemented by a combination of programmed software, hardware, and communication resources. Therefore, an action planning unit, an action management database, an action item scheduler, an action item notifier, an action item response unit can be provided within the MECA action platform 10 in one exemplary embodiment.

Other embodiments of the invention will be apparent to those skilled in the art from a consideration of the specification and the practice of the invention disclosed herein. It is intended that the specification be considered as exemplary only, with the true scope and spirit of the invention being indicated by the following claims.

What is claimed is:

1. A computer implemented method of planning and managing an initiative, the method comprising the steps of:
planning the initiative by determining the initiative tasks;
generating an action plan including action items to accomplish the initiative tasks; and
generating a dynamic organizational model to support the execution of the action plan, the organizational model comprising initiative participants, relationships between the initiative participants, other business entities, and attributes of the initiative participants and the other business entities.

2. The computer implemented method of planning and managing an initiative according to claim 1, wherein the step of generating an organization model is itself an initiative.

3. The computer implemented method of planning and managing an initiative according to claim 2, wherein the step of generating an organizational model comprises:
identifying an initial set of initiative participants including attributes and relationships associated therewith, with reference to user input and/or existing organizational information;
generating notifications and queries to the initial set of initiative entities and/or related participants;
collecting responses to the generated notifications and queries; and
iteratively updating the initial set of initiative participants by adding or deleting initiative participants and/or altering the attributes and relationships associated therewith based on the collected responses.

4. The computer implemented method of planning and managing an initiative according to claim 1, further comprising the step of:
identifying initiative participants for assigning action items with reference to the organizational model; and
notifying the identified initiative participants of the assigned action items.

5. The computer implemented method of planning and managing an initiative according to claim 4, wherein the step of notifying the identified initiative participants of the assigned action items includes providing instructions and/or training on how to complete the assigned action items.

6. The computer implemented method of planning and managing an initiative according to claim 4, wherein the step of identifying the initiative participants includes identifying based on attributes or roles of the initiative participants.

7. The computer implemented method of planning and managing an initiative according to claim 4, wherein the step of identifying the initiative participants includes iteratively collecting responses from other initiative participants regarding assignment of action items.

8. The computer implemented method of planning and managing an initiative according to claim 4, wherein the step of identifying initiative participants for assigning action items includes evaluating the results or outcomes of prior action items.

9. The computer implemented method of planning and managing an initiative according to claim 1, wherein the initiative participants include one or more employees, contractors, agents, vendors, or customers of an organization.

10. The computer implemented method of planning and managing an initiative according to claim 1, wherein two action items are chained such that one action item is only initiated when a previous action item is at least partially completed.

11. The computer implemented method of planning and managing an initiative according to claim 1, wherein the step of generating an action plan comprises receiving input from action directors, business process teams, and content authors.

12. The computer implemented method of planning and managing an initiative according to claim 4, further comprising providing action support teams that assist and monitor the execution of assigned action items.

13. The computer implemented method of planning and managing an initiative according to claim 12, wherein the action support teams include call center or web based interactive response teams.

14. The computer implemented method of planning and managing an initiative according to claim 1, wherein the action items include one or more of notifications and communications, queries, surveys, and data forms, assignments of roles and tasks, training and instructions, and directives to perform certain actions.

15. The computer implemented method of planning and managing an initiative according to claim 4, further comprising the step of tracking the execution of action items.

16. The computer implemented method of planning and managing an initiative according to claim 15, wherein the execution of an action item includes the steps of:
targeting an initiative participant for assigning the action item;
notifying the targeted initiative participant of the assigned action item;
interactively communicating with the targeted initiative participant regarding completing the assigned action item; and
recording outcome of the assigned action item.

17. The computer implemented method of planning and managing an initiative according to claim 16, wherein the step of targeting an initiative participant comprises using personnel or other organizational profiles, previous action items, or receiving user input.

18. The computer implemented method of planning and managing an initiative according to claim 16, wherein the step of notifying the targeted initiative participant includes providing one or more of e-mail messages, voice mail messages, pager or PDA alerts, facsimile, or mail messages.

19. The computer implemented method of planning and managing an initiative according to claim 16, wherein the step of interactively communicating with a targeted initiative participant includes providing web forms or questionnaires, and receiving and verifying inputs responsive to the web forms or questionnaires.

20. The computer implemented method of planning and managing an initiative according to claim 19, wherein the step of interactively communicating with a targeted initiative participant further includes authenticating the initiative participant, providing action item specific training, instructions, or content to the initiative participant, validating the input of the initiative participant against rules or additional information, and/or confirming the input of the initiative participant with the input of a confirmation entity.

21. The computer implemented method of planning and managing an initiative according to claim 16, wherein the step of recording outcome of the action item includes the steps of updating the action item completion status, generating reports or feedback regarding outcome of action items, initiating new action items dependent on the outcome of the action item, and/or modifying the targeting of initiative participants for particular action items.

22. The computer implemented method of planning and managing an initiative according to claim 16, wherein the step of tracking the execution of action items comprises generating reports and measures of the progress of action item completion for individual action items as well as for groups of action items.

23. The computer implemented method of planning and managing an initiative according to claim 16 wherein the step of tracking the progress of action items comprises tracking the completion of action items and escalating the notifications if the completion of action items lag behind defined parameters.

24. The computer implemented method of planning and managing an initiative according to claim 23, wherein the defined parameters include one or more of target dates, response content, input from others, and
wherein escalating the notifications includes one or more of changing the notification media, notifying other initiative participants, or reassigning action items to other initiative participants.

25. The computer implemented method of planning and managing an initiative according to claim 24, wherein the escalating the notification is performed in stages corresponding to target date approaching, target date reached, or target date past due, and wherein the escalating steps are different at the different stages.

26. The computer implemented method of planning and managing an initiative according to claim 25, wherein the escalating steps comprise notifying using a different notification media when the target date is approaching, notifying a supervisor when the target date is reached, and reassigning the action item when the action item is past due the target date.

27. The computer implemented method of planning and managing an initiative according to claim 3, wherein the step of generating the organization model further comprises updating and regenerating the organizational model based on outcomes of action items.

28. The computer implemented method of planning and managing an initiative according to claim 4, wherein the step of notifying the identified initiative participants comprises personalizing the content of the action item.

29. The computer implemented method of planning and managing an initiative according to claim 28, wherein the step of personalizing the content of the action item is performed by using the attributes of the initiative participant and/or other information stored in the organizational model.

30. A computer readable medium having program code recorded thereon for planning and managing an initiative, the program code configured to cause a computing system to perform the following steps:
planning the initiative by determining the initiative tasks;
generating an action plan including action items to accomplish the initiative tasks; and
generating a dynamic organizational model to support the execution of the action plan, the organizational model comprising initiative participants, relationships between the initiative participants, other business entities, and attributes of the initiative participants and the other business entities.

31. The computer readable medium according to claim 30, having program code configured such that the step of generating an organizational model comprises:
identifying an initial set of initiative participants including attributes and relationships associated therewith, with reference to user input and/or existing organizational information;
generating notifications and queries to the initial set of initiative participants and/or related entities;
collecting responses to the generated notifications and queries; and
iteratively updating the initial set of initiative participants by adding or deleting initiative participants and/or altering the attributes and relationships associated therewith based on the collected responses.

32. The computer readable medium according to claim 30, having program code configured to further perform the steps of:
identifying initiative participants for assigning action items with reference to the organizational model; and
notifying the identified initiative participants of the assigned action items.

33. The computer readable medium according to claim 32, having program code configured to further perform the step of tracking the execution of action items.

34. The computer readable medium according to claim 33, having program code configured such that the execution of an action item comprises:
targeting an initiative participant for assigning the action item;
notifying the targeted initiative participant of the assigned action item;
interactively communicating with the targeted initiative participant regarding completing the assigned action item; and
recording outcome of the assigned action item.

35. The computer readable medium according to claim 34, having program code configured such that he step of targeting an initiative participant comprises using personnel other organizational profiles, previous action items, or receiving user input.

36. The computer readable medium according to claim 34, having program code configured such that the step of notifying the targeted initiative participant includes providing one or more of e-mail messages, voice mail messages, pager or PDA alerts, facsimile, or mail messages.

37. The computer readable medium according to claim 34, having program code configured such that the step of interactively communicating with a targeted initiative participant includes providing web forms or questionnaires, and receiving and verifying inputs responsive to the web forms or questionnaires.

38. The computer readable medium according to claim 37, having program code configured such that the step of interactively communicating with a targeted initiative participant further includes authenticating the initiative participant, providing action item specific training, instructions, or content to the initiative participant, validating the input of the initiative participant against rules or additional information, and/or confirming the input of the initiative participant with the input of a confirmation entity.

39. The computer readable medium according to claim 34, having program code configured such that the step of recording outcome of the action item includes the steps of updating the action item completion status, generating reports or feedback regarding outcome of the action items, initiating new action items dependent on outcome of the action item, and/or modifying the targeting of initiative participants for particular action items.

40. The computer readable medium according to claim 34, having program code configured such that the step of tracking the execution of action items comprises generating reports and measures of the progress of action item completion for individual action items as well as for groups of action items.

41. The computer readable medium according to claim 34, having program code configured such that the step of tracking the execution of action items comprises tracking the completion of action items and escalating the notifications if the completion of the action items lag behind defined parameters.

42. The computer readable medium according to claim 41, having program code configured such that the defined parameters include one or more of target dates, response content, input from others, and
wherein escalating the notifications includes one or more of changing the notification media, notifying other initiative participants, or reassigning action items to other initiative participants.

43. The computer readable medium according to claim 42, having program code configured such that the escalating of the notifications is performed in stages corresponding to target date approaching, target date reached, and target date past due, and wherein the escalating steps are different at the different stages.

44. The computer readable medium according to claim 43, having program code configured such that the escalating steps comprise notifying using a different notification media when the target date is approaching, notifying a supervisor when the target date is reached, and reassigning the action item when the action item is past due the target date.

45. The computer readable medium according to claim 31, having program code configured such that the step of generating the organization model further comprises updating and regenerating the organizational model based on outcomes of action items.

46. The action item management system for planning and managing an initiative comprising:
an action planning unit for generating an action plan comprising action items to complete the initiative tasks;
an action management database for storing a dynamically generated organizational model and information relating to the action items;
an action item scheduler for assigning and scheduling action items;
an action item notifier for notifying initiative participants of assigned action items; and
an action item response unit for receiving action item responses from initiative participants and updating the action management database,
wherein the action planning unit iteratively and dynamically generates the organizational model based on organizational information and responses received from initiative participants.
